(19) United States
(12) Patent Application Publication
(10) Pub. No.: US 2019/0236124 A1
(43) Pub. Date: Aug. 1, 2019

(54) SYSTEMS AND METHODS FOR CREATING A DYNAMICALLY EDITABLE DOCUMENT TEMPLATE AND FOR DRAFTING, REVIEWING, NEGOTIATING, AND FINALIZING A DYNAMICALLY EDITABLE DOCUMENT

(71) Applicant: First Cut Technologies LLC, Lebanon, NJ (US)

(72) Inventors: Colin Bumby, Astoria, NY (US); James Charney, Astoria, NY (US); Adam Baldwin, Whitehouse Station, NJ (US)

(21) Appl. No.: 15/886,790

(22) Filed: Feb. 1, 2018

(51) Int. Cl. G06F 17/24; G06Q 10/10

(52) U.S. Cl. CPC G06F 17/248; G06F 17/241; G06Q 10/101; G06F 17/243

(57) ABSTRACT

Systems and methods for reviewing, drafting, and negotiating a dynamically editable document are disclosed. Exemplary embodiments may: receive a template request, generate a drafter interface generate a drafter interface, the drafter interface comprising a dynamically editable document and one or more prompts and corresponding responses corresponding to the dynamically editable document; receive responses; invoke listeners; record and distribute the responses, and record edits. An exemplary embodiment may: generate a manager interface, the manager interface comprising one or more prompt section fields, one or more segment fields, one or more prompt fields, one or more response fields, and one or more listener fields; create one or more prompt sections; create one or more segments; create one or more prompts; create one or more responses; create one or more listeners that are invoked based on receiving the one or more responses; and generate a dynamically editable document template.

### TECHNICAL FIELD

The disclosed technology relates generally to dynamically editable documents, and more particularly, several embodiments relate to systems and methods for creating a dynamically editable document template, and for drafting, reviewing, negotiating, and finalizing dynamically editable documents.

### DESCRIPTION OF THE RELATED ART

Document comparison systems are commonly known as redlining or blacklining systems. These systems help identify changes between different versions of the same document and are heavily used for various industries, especially the legal industry. These systems are often used by business professionals, in conjunction with word processing tools to assist them in drafting, collaborating on, reviewing, revising and negotiating documents. As one example, attorneys often use word processing systems and document comparison systems to create draft legal documents and to facilitate the process of reviewing, negotiating and finalizing legal documents such as, for example, contracts and agreements, as well as other legal documents. As a more specific instance of this example, an attorney and his or her client may use document redlining tools to allow the attorney to receive and incorporate client input on a document. The attorney may then share the document with opposing counsel, at which point a drafting attorney and the responding attorney (opposing counsel) may negotiate changes and exchange redlined and commented documents to highlight and explain desired changes.

Document generation, or document assembly, tools are also used in a legal context to assist in drafting standard legal documents. As one example, a person with no legal experience may answer a questionnaire that is used to generate a standard document. In another example, a lawyer may construct a standard agreement that has multiple variables. The lawyer may be able to create fields that present other readers with a description of the blank field and the field allows for an editor to populate the field. It may even allow a lawyer to create various permutations of the document based on the context, where certain permutations are hidden until selected.

Conventionally, the process for drafting, reviewing, negotiating and finalizing documents, including via the use of word processors and document comparison systems, suffers from being expensive, time consuming and subject to human error. Also, document comparison systems are not capable of tracking specific changes through multiple iterations and fail to provide a user interface for quickly drafting, reviewing, negotiating or finalizing documents.

In the context of a legal agreement, for instance, in order to get to a negotiated deal, lawyers for each party, when they receive a draft agreement from another party, must (i) review the agreement word-by-word and extrapolate issues out of the words of the draft agreement, (ii) raise the issues with the client, (iii) draft on a word processor a revised agreement word-by-word and using precedent to reflect the lawyer's and the lawyer's client's proposed resolutions of the issues and (iv) send the revised agreement and a blackline to the other party or parties using a document comparison system against the prior draft agreement (and, at times, other drafts). To finalize a draft of the agreement, each of the parties to the agreement and their lawyers may repeat this process (many times if necessary), incorporating in person or telephonic negotiations, until all issues are resolved. Depending on the size of the document, this process may require significant time and attention from each party's lawyer(s) and may involve a long history of redlines back and forth between the lawyers. The more time it takes for the lawyers to draft a document and review, negotiate, and finalize the document, the more expensive it will be for the clients. Additionally, the longer it takes to finalize a deal, the more likely it is that the deal falls apart.

Often, lawyers may draft documents by starting from either precedents they have from old matters or templates or forms, copying and conforming certain clauses from other documents, editing the document on a word-by-word basis and other methods. These conventional techniques often require the lawyer to draft word-by-word and comma-by-comma, which increases the risk of human errors. Moreover, other “human” factors, such as inexperience, lack of sophistication, lack of knowledge of what terms are “market” and/or customary, varying skill level, deadlines and inattention may introduce additional errors or further slow the process.

Reviewing a document may also be difficult and inefficient because, among other things, changes to documents are not always properly preserved, the format of the documents may not be in a standardized style, the document may not be well written, may be unclear, and may not highlight how issues are addressed or resolved and/or other difficulties may arise. This can, among other things, increase the cost of review and/or lead to human error.

This traditional process can also lead to inefficiencies in negotiating. For example, the lawyers and their clients may be negotiating and may not have clarity on the issues and positions being discussed, which could happen for many reasons. These reasons may include, for example, because the lawyer reviewing the words and extrapolating into issues may misconstrue the issue being addressed, because the client may misconstrue the issues being raised by its lawyer, or because of other communications breakdowns. Alternatively, the parties may agree on a resolution of the issue but may not agree on whether the words one party drafts properly reflect that resolution or may not consider the further issues created by that resolution. This process can add time and complexity to a negotiation. In addition to increased costs, this process of negotiating may, if for example a lawyer misses an issue or doesn't understand an issue or if the word-by-word drafting doesn't properly resolve the issue, increase the client's risk profile associated with the Agreement.

### SUMMARY

Embodiments of the systems and methods disclosed herein provide systems and methods for creating a dynamically editable document template. Additional embodiments provide systems and methods for drafting, reviewing, negotiating, and finalizing a dynamically editable document. A drafter interface may be provided in various embodiments. A simple questionnaire may be included and presented on the drafter interface to guide the document drafter through the document creation process with a series of prompts, and provide context by dynamically changing the document based on the responses the drafter provides to the prompts. The issues, positions, and actual words of the agreement (or other document) may become integrated in a drafter interface to allow a document drafter to review and draft documents, such as legal documents, more quickly and more efficiently.

In various embodiments, a first draft of the document may be created by incorporating standardized language into the document based on responses to the prompts as provided by the drafter. Similarly, subsequent turns of the draft may likewise be created by incorporating standardized language selected based on responses to the prompts as provided by the opposing party. By providing a system that allows sections of the document to be created using standardized language chosen by the system based on responses to the provided queries, human error may be reduced, thereby allowing, in the context of legal documents, the drafting party to reduce its risks. Similarly, the amount of time spent drafting documents at a more granular, word-by-word, level may be reduced. In further embodiments, particular spans of words in a document may be tied to an issue and a position on that issue, so the parties may understand each other's positions during negotiation. Additionally, granular wording changes made to the document may be recorded in such a manner that would allow the receiving party to determine what changes any drafting party has made to the document.

According to various embodiments of the disclosed technology, a dynamically editable document interface may be used to draft, review, negotiate, and finalize documents. Moreover, a tool may be used to create document templates from which new documents can be drafted. Embodiments may be implemented to streamline the way documents may be created as compared to existing technologies. As one example, negotiations over a document may often take place that discuss various concepts. However, what one party may mean by a certain concept may not be how it is understood by a different party. When one party drafts a document, the party may use its own definitions of a concept. When the other party reviews this document, they must start the negotiations and conversations from scratch. However, embodiments may be implemented in which concepts are directly tied to document language on a graphical user interface, so there is less confusion regarding what is meant by any term. Moreover, because one or more predefined segments (e.g., blocks of text, numbers, symbols, etc.) may be added to the document based on responses to discrete prompts made by the system, the amount of error produced by a user is reduced. The user no longer needs to work at a granular level to type each letter and term into a document. In addition, any changes made to the document may be preserved so that a user may view the history of a document with ease and see how certain terms were changed over the course of the document changes.

According to an embodiment of the disclosed technology, a method for reviewing, drafting, and negotiating a dynamically editable document comprises receiving a template request; generating, on a first graphical user interface, a drafter interface corresponding to the template request, the drafter interface comprising a dynamically editable document and one or more prompts and corresponding responses corresponding to the dynamically editable document, wherein a given prompt corresponds to a given prompt section; receiving a first set of one or more responses to individual ones of the one or more prompts from a drafter; invoking listeners corresponding to the template request, such that the drafter interface is modified based on the one or more responses; recording the first set of one or more responses and distributing the first set of one or more responses to a reviewer; and recording a first set of one or more edits to the dynamically editable document.

According to an embodiment of the disclosed technology, a method for creating a dynamically editable document template comprising generating, on a graphical user interface, a manager interface, the manager interface comprising one or more prompt section fields, one or more segment fields, one or more prompt fields, one or more response fields, and one or more listener fields; responsive to input from a manager on the one or more prompt section fields, creating one or more prompt sections presented to a drafter; responsive to input from the manager on the one or more segment fields, creating one or more segments presented to the drafter, wherein the one or more segments correspond to the one or more prompt sections; responsive to input from the manager on the one or more prompt fields, creating one or more prompts presented to the drafter, wherein the one or more prompts correspond to the one or more prompt sections; responsive to input from the manager on the one or more response fields, creating one or more responses presented to the drafter, wherein the one or more responses correspond to individual ones of the one or more prompts; responsive to input from the manager on the one or more listener fields, creating one or more listeners that are invoked based on receiving the one or more responses from the drafter, wherein the one or more listeners correspond to the one or more prompt sections; and generating a dynamically editable document template based on the manager's inputs, wherein the dynamically editable document template corresponds to a drafter interface for the drafter and wherein the drafter interface comprises a dynamically editable document and the one or more prompts and corresponding responses corresponding to the dynamically editable document.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a system configured to draft, review, negotiate, and finalize a dynamically editable document and to create a dynamically editable document template, in accordance with one embodiment of the technology described herein.

FIG. 2 illustrates a method for drafting a dynamically editable document, in accordance with one embodiment of the technology described herein.

FIG. 3 illustrates a method for creating a dynamically editable document template, in accordance with one embodiment of the technology described herein.

FIG. 4 illustrates an example view of an interface for drafting, reviewing, negotiating and finalizing a dynamically editable document, in accordance with one embodiment of the technology described herein.

FIG. 5 illustrates an example view of an interface for drafting, reviewing, negotiating and finalizing a dynamically editable document, in accordance with one embodiment of the technology described herein.

FIG. 6 illustrates an example view of an interface for drafting, reviewing, negotiating and finalizing a dynamically editable document, in accordance with one embodiment of the technology described herein.

FIG. 7 illustrates an example view of an interface for drafting, reviewing, negotiating and finalizing a dynamically editable document, in accordance with one embodiment of the technology described herein.

FIG. 8 illustrates a view of an example interface for drafting, reviewing, negotiating and finalizing a dynamically editable document, in accordance with one embodiment of the technology described herein.

FIG. 9 illustrates an example view of a tool for creating a dynamically editable document template, in accordance with one embodiment of the technology described herein.

FIG. 10 illustrates an example view of a tool for creating a dynamically editable document template, in accordance with one embodiment of the technology described herein.

FIG. 11 illustrates an example computing component that may be used in implementing various features of embodiments of the disclosed technology.

FIG. 12 illustrates a system configured to draft, review, negotiate, and finalize a dynamically editable document and create a dynamically editable document template, in accordance with one embodiment of the technology described herein.

FIG. 13 illustrates a method for drafting, reviewing, negotiating, and finalizing a dynamically editable document and creating a dynamically editable document template, in accordance with one embodiment of the technology described herein.

FIG. 14 illustrates an example view of a drafter interface, in accordance with one embodiment of the technology described herein.

FIG. 15 illustrates a method for reviewing, negotiating, and finalizing a dynamically editable document, in accordance with one embodiment of the technology described herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Embodiments of the technology disclosed herein are directed toward systems and methods for automatically generating a document based on responses to prompts provided to the document drafter. In various applications, the system can be configured to present the document drafter with a series of prompts or other prompts about the document the drafter intends to create. The system uses responses provided by the drafter to select predetermined content items for the document (e.g., segments), and assembles those predetermined content items to create the first draft document. The drafter may make edits to the document, if desired, including word-by-word editing. In this way, a first draft of a desired document can be automatically created by the system selecting and assembling content items into a finished document based upon the drafter's responses to queries about the document.

According to another aspect of the technology disclosed herein, systems and methods may be provided to allow one or more of a document reviewer (e.g., opposing counsel, supervisor of the drafter, client or customer of the drafter, colleague or peer of the drafter, and so on) to revise the document and turn a revised draft of the document back to the drafter. According to various embodiments, the reviewer may also be presented with a series of prompts or queries regarding document topics and, based on the reviewer's responses, changes to the document can be made. As with the original draft, these changes can be in the form of predetermined document content items selected and plugged into the document based on the reviewer's responses.

According to another aspect of the technology disclosed herein, systems and methods may be provided to record the changes made by the document drafter and the document reviewer (e.g. in the case of a legal document, changes made by the drafting attorney and opposing counsel), and to allow changes to the document to conform to predefined content. According to yet another aspect of the disclosed technology, systems and methods may be provided to allow a dynamically editable document template to be created. The dynamically editable document template can provide the foundation from which the system presents prompts to a drafter and creates draft documents based on responses.

This technology can be used in a variety of industries and applications. In one example, the technology may be useful for lawyers or others drafting, reviewing, negotiating, and finalizing legal documents, as well as for creating a dynamically editable document template. In other industries, the systems and methods disclosed herein can be used for drafting, reviewing, negotiating, and finalizing a variety of other document types including, for example, proposals, white papers, and journal articles.

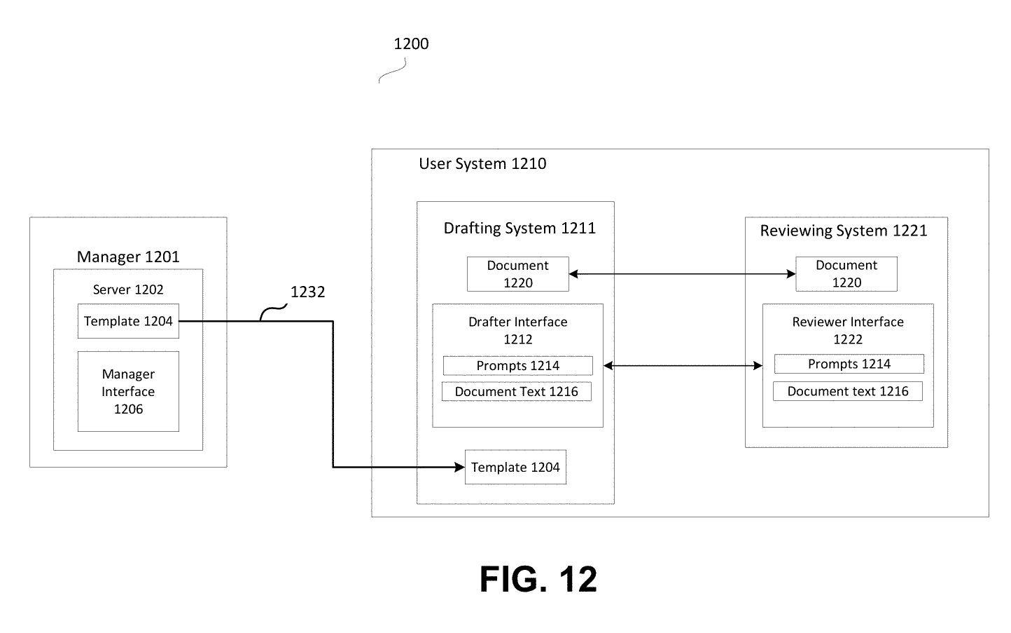

FIG. 12 illustrates an example of a system 1200 configured for drafting, reviewing, negotiating, and finalizing a document and creating a dynamically editable document template, in accordance with one or more embodiments. The example illustrated in FIG. 12 includes a manager 1201 and a user system 1210. User system 1210 includes a drafting system 1211 and a reviewing system 1221. Manager 1201 may include server 1202, which may be configured by machine-readable instructions. Machine-readable instructions may include one or more computer program code components to effectuate the features of the technology disclosed herein. Server 1202 may execute the instructions to generate document template 1204 in response to manager input. The server may execute instructions to create manager interface 1206. Manager interface 1206 may be presented to the manager to provide an interface by which the manager can generate one or more document templates 1204.

Manager 1201, drafting system 1211 and reviewing system 1221 may include wired or wireless communications interfaces to facilitate communications between or among these various components. These can include, for example, wired or wireless communications transmitters and receivers to allow the components to communicate with one another via direct medications links, communications networks (e.g., via the Internet), or other communications interfaces. For example, manager 1201 is communicatively coupled to drafting system 1211 via a communications interface (not illustrated). As illustrated by flow line 1232, manager 1201 can be configured to transmit a document template 1204 to a drafting system 1211. In some embodiments, this transmission can be at the request of drafting system 1211.

The drafter at drafting system 1211 can call up a selected document template 1204 and use the document template to create a draft document 1220. Drafter interface 1212, which may be presented as a graphical user interface, may present one or more input screens to the drafter at drafting system 1211 (e.g., the document drafter) to facilitate this process of creating a draft document 1220 from a dynamically editable document template 1204. As illustrated in this example, drafter interface 1212 may include prompts 1214 and document text 1216. Examples of a drafter interface 1212 are described in more detail below.

Drafting system 1211 may communicate with reviewing system 1221. In the illustrated embodiment, drafting system 1211 may communicate with reviewing system 1221 without routing communications through manager 1201. Particularly, in this example, drafting system 1211 shares document 1220 with reviewing system 1221. However, in other embodiments, drafting system 1211 and reviewing system 1221 may communicate with one another via manager 1201. Although not illustrated in this example, manager 1201 may also share documents with reviewing system 1221. For example, reviewing system 1221 may also receive one or more templates 1204 from manager 1201 so that reviewing system 1221 can create its own draft documents.

In the illustrated example, reviewing system 1221 includes reviewer interface 1222. Similar to drafter interface 1212, reviewer interface 1222 can present a graphical user interface to present one or more input screens to the reviewer at reviewing system 1221 (e.g., a document reviewer). In various embodiments, reviewer interface 1222 can present document text 1216 of the draft document 1220 to the reviewer along with prompts 1214 associated with the draft document 1220. This can facilitate review of and revisions to document 1220 by the document reviewer, including changing responses and making changes to the presented text. Once the document reviewer has completed reviewing and revising the draft document 1220, the document reviewer can transmit draft document 1220 back to drafting system 1211 so that the document drafter can see the changes (if any). At this point, the document drafter reviews draft document 1220, makes revisions if desired (e.g., changes responses and makes changes to the text of the document) and may send a revised draft document 1222 to the document reviewer at reviewing system 1221. This process may continue between both parties as they negotiate final terms of the document until there are no remaining issues in the document and the document is agreed upon by both parties.

Although not illustrated in the example of FIG. 12, manager 1201 can be configured to generate a plurality of templates for a plurality of document types. Also not illustrated in FIG. 12, reviewing system 1221 may also function as a drafting system, and drafting system 1211 may also function as a reviewing system. For example, the reviewer at reviewing system 1221 may retrieve template 1204 from which to draft a new document this user (e.g., a document drafter) may then send the completed draft to a document reviewer for negotiation. Similarly, a drafter at drafting system 1211 may receive a draft document that was created by another system and review and revise that document using the drafter's user interface. Accordingly, in various embodiments, the document management systems can function as drafting systems and reviewing systems. Also, although only one manager, drafting system and reviewing system is illustrated, in various embodiments there can be multiple instances of any or all of the systems.

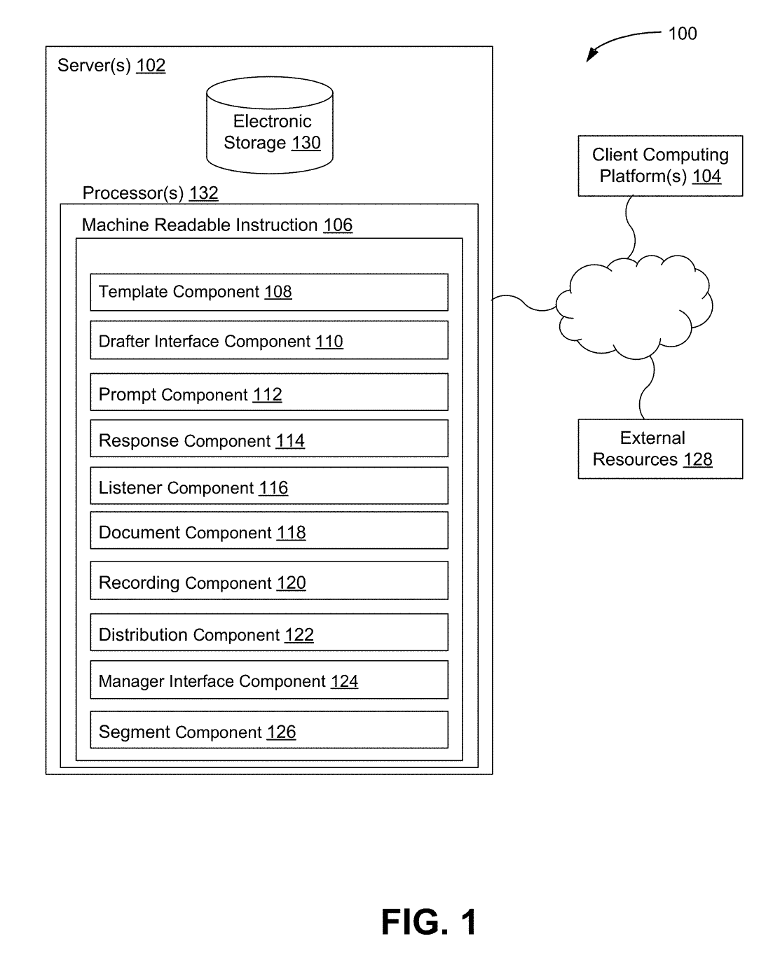

FIG. 1 illustrates a system 100 configured for drafting, reviewing, negotiating, and finalizing a document and creating a dynamically editable document template, in accordance with one or more embodiments. In some embodiments, system 100 may include one or more server(s) 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Drafters, reviewers, and/or managers may access system 100 via client computing platform(s) 104.

Server(s) 102 may be configured by machine-readable instructions 106. Machine-readable instructions 106 may include one or more computer program code components to effectuate the features of the technology disclosed herein. The computer program code components may include one or more of a template component 108, drafter interface component 110, a prompt component 112, a response component 114, a listener component 116, a document component 118, a recording component 120, a distribution component 122, a manager interface component 124, a segment component 126, and/or other instruction components.

Template component 108 may be configured to present one of the drafter interfaces to a drafter. A drafter may request one of the templates, such that the requested template may be associated to one of the drafter interfaces. For example, a template may include a template for any of a variety of documents. For example, in a legal setting, the template may include a non-disclosure agreement, a licensing agreement, an indemnity agreement, a non-compete agreement, an independent contractor agreement, and/or other agreements. In another example, the template may be a white paper, a journal article, proposals, and/or other documents.

In some embodiments, specific configurations that go into template component 108 define the specific prompts and responses that appear. Templates may be created, edited, modified, copied, deleted, and/or otherwise affected in a manager interface component 124. The operations may be reflected in the dynamically editable document presented to the drafter. Portions of a template may be copied or merged (and modified if desired) for use in another template. For example, a segment or segments and the appropriate prompt(s) and response(s) for a Notice Provision from one template may be copied or merged to a non-disclosure agreement template as one section of the non-disclosure agreement template. As another example, segments and their corresponding prompts and responses for a Miscellaneous Provision section of one template may be copied or merged for use in another document template. Manager interface component 124 can provide the tools used by a manager generating a dynamically editable document template. For example, in some embodiments manager interface component 124 can be configured to present prompts to a user, which may include a drafter and a reviewer, along with a series of segments corresponding to the prompts and their responses which may be created through a listener connecting specific text changes to responses.

Drafter interface component 110 may be configured to generate a drafter interface on a graphical user interface. The drafter interface may include a dynamically editable document and one or more dynamic prompts associated with the document. The graphical user interface may include a user interface based on graphics, text, or both; and in some implementations a drafter may interact with the interface by using a capacitive touchpad, a computer mouse, computer keyboard, or any other an input device.

The drafter interface component 110 may also include one or more interfaces. For example, a document navigator interface, a prompt view interface, an issues list interface, a blackline interface, and an edit interface.

In some embodiments, the dynamically editable document may be provided for display in one portion of the graphical user interface, and a series of prompts in another portion of the GUI. The dynamically editable document, through the use of prompts, may allow the drafter to draft, review, negotiate and finalize documents. In some embodiments, the one or more dynamic prompts may be provided for display on the graphical user interface such that the drafter may see both the dynamically editable document as well as the one or more dynamic prompts.

In some embodiments, a dynamically editable document template may include one or more segments and/or other text. Segments may include, one or more words, sections, clauses, sentences, paragraphs, letters, numbers, symbols, punctuation marks, spans, images, or any combination of the foregoing. As described below, the segments can be mapped to or associated with responses to prompts.

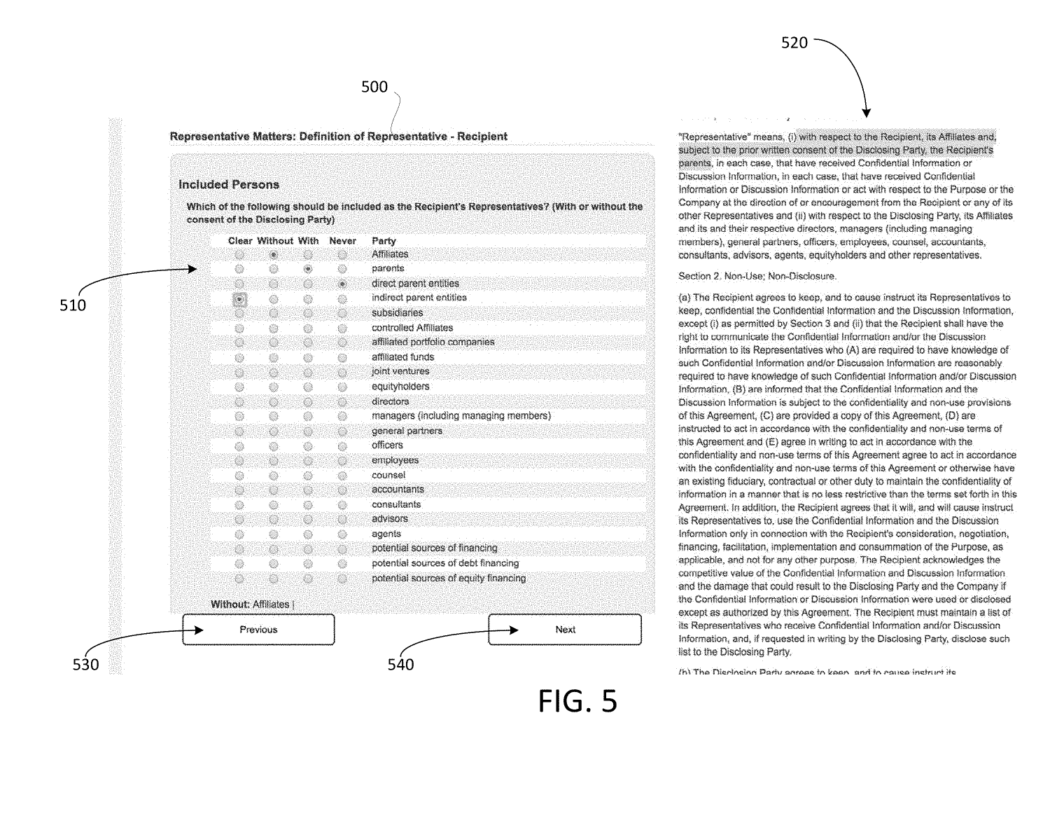

In some embodiments, the one or more prompts may include questions, queries, or other prompts presented to the drafter (and, in some embodiments to the reviewer once the reviewer receives the document). The one or more prompts may be associated to a prompt section, which may be associated to a section of the document. The section of the document may be associated to a section in the document navigator interface. As described more fully below, when the drafter opens a document template to draft a new document, the drafter interface presents a series of prompts (which may be tied to document sections) which query the drafter for a response. The prompts may, for example, provide radio buttons, check marks, open-ended response space, lists, complex lists, or other prompt types. When the drafter responds to a prompt, the system may use the response in the document creation process. For example, selection of one of a group of radio buttons may cause a listener in the system to select a segment associated with the chosen response and include the segment in the document being generated (in some embodiments, all spans are present in the template and the non-selected spans deleted). The response may also cause the document generation system to alter future prompts that are to be presented to the drafter in the drafting process. In some embodiments, responding to a prompt records the answer and distributes the answer to an opposing party. In one example, a complex list may include a list of potentially relevant parties to a document and multiple options corresponding to what degree each party may be relevant, such as the list shown in FIG. 5.

A document navigator interface may include a dynamic table of contents. The table of contents may be populated with document sections and associated sub-sections. The document sections may be selected such that the associated prompts for a selected section are displayed on the drafter interface and the associated portion of the document is displayed on the drafter interface. In some embodiments, the dynamic table of contents may be updated to reflect responses to various prompts. Also, the document may automatically scroll to a specific prompt or response when a drafter or reviewer clicks on a portion of the relevant segment of the document.

A prompt view interface may include a set of prompts and a document. This view may be similar to the drafter interface initially presented to the drafter.

An issues list interface may include all points of disagreement between parties associated with a document (e.g., between the drafter and the reviewer). The issues list may include a listing of the instances in which the drafter and the reviewer elected different responses to one of the prompts, as well as any edits received by one party from the other party. When the parties reach agreement on an issue, that issue is removed from the issues list (but, in some applications, may be saved, including in a negotiation history file, or for use in creating another document from the same template). For example, if a reviewer makes a change to the document, that change shows up as an open issue on the issues list. If the drafter, upon turning the document does not alter a portion of the document revised by the reviewer, this revision may be deemed to have been accepted, and the associated issue may be removed from the issues list interface. In this manner, a running list of open issues can be created and updated automatically based on areas of ‘disagreement’ flagged based on different responses to prompts or edits to the document.

A blackline interface may be displayed on the drafter interface such that a party may see a history of the document. An immutable historic record may be kept of the document as the document is exchanged between opposing parties in a blackline interface. The system may have the ability to capture this immutable historic record, or a ledger, within an etherium or block chain framework, including through the creation of private block chain networks between negotiating parties as well as capturing an immutable ledger of document changes. Individual points in the immutable historic record may be used in another document.

In one example, a first drafter from a first party may be able to compare earlier recorded responses and edits to the document against the later recorded responses and edits to the document after it was sent by the opposing party back to the first drafter. The first drafter may also be able to compare the first drafter's current recorded responses and edits against earlier recorded responses and edits to the document distributed by the second party. The first drafter may be able to compare the current recorded responses and edits to other recorded responses made by the first drafter. A drafter may also be able to compare the drafter's current recorded responses to the original document distributed by the drafter. The drafter may be able to compare various other points in the document history against any other point in the document history.

An edit interface may be displayed on the drafter interface such that a party may see edits to the text on the document. The edit interface may allow a drafter to make more granular changes to the document, such as modifying punctuation, a letter, a number, a word, a segment, and/or other text. The edit interface may be associated with one of the segments. A first drafter's edits may be displayed in a first style. A second drafter's edits may be displayed in a second style. The first drafter and the second drafter may be from a first party. A first style may be different than a second style. The first style may be a different size, shape, color, highlight, underline, font, and/or other difference than the second style. For example, a first style may color a first drafter's edits in blue and a second style may color a first drafter's edits in red.

In some applications, internal edits can be tracked among a group collaborators of one party before being accepted as the party's ‘final’ edits and sent to the other party in an edit interface. This can allow internal collaboration and agreement (e.g., among a legal team or by lawyer(s) and their client(s)) so that consensus can be reached before the response is sent to the other side. When the document is sent to the opposing party, the opposing party may see at least some of the edits made on that round of negotiating the document.

Prompt component 112 may be configured to present one or more prompts to the user. For example, prompt component 112 may present prompts to a drafter, the responses to which are used to assemble the draft document. As another example, prompt component 112 may present further prompts to a reviewer as a to facilitate receiving input from the reviewer from which the draft may be revised. Various prompts can be associated with sections in the document, and can be associated with the document table of contents.

Prompt component 112 may also be configured to present a manager with a prompt section field so that the manager can build prompts for the document template. The prompt section may be associated with a document template, and the prompt section field may be further identified by the manager. A prompt section field may be associated with a particular section in the table of contents in the document navigator, the prompt section field identified by the manager. Accordingly, a prompt section field may be associated to a prompt section in a document with an associated label, such that the labeled prompt section field is used in the document by linking fields in prompt component 112 through the use of segments and listener component 116. These enable corresponding segments of the document to be updated when the drafter responds to the prompts.

Prompt component 112 may also be configured to present a manager with a prompt field. The prompt field is associated with one of the prompt sections. The prompt field may be labeled by the manager, allowing for an infinite degree of customization of prompt fields, providing prompts and modifying the document based upon responses. The prompt field may be used in the one or more prompts, such that the label prompt field is displayed to the drafter based upon the customization configured in the drafter interface component 110.

Prompt component 112 may also be configured to present a manager with a prompt type. The prompt type may include one or more field holders or prompt types. Examples of a prompt type can include a yes-or-no type prompt, a radio button prompt, a drop-down menu, a date field, field holders, complex lists, and other types of prompts, providing a large range of variability for prompts and responses in the prompt component. The prompt type may affect a response type available the manager. The prompt type selected may affect how a prompt is presented to the drafter.

Response component 114 may be configured to present one or more responses associated with one of the prompts. Responses may include answers, replies, statements, and other comments provided by the drafter or reviewer in response to a prompt. In some embodiments, predetermined responses can be provided to the user using, for example, radio buttons or a drop-down menu that allow a user (drafter or reviewer) to choose one or more discrete options. These options may be predefined by the manager when that document template is created. In the case of a manager system (e.g., manager 1201) response component 114 may allow the manager to create particular responses to the prompt such as, for example, contents of the radio-button selections or drop-down menu items, date selectors, duration selectors, lists, complex lists, and other responses.

During drafting, a drafter may provide a response, which in turn is used to build the draft document as described below. In various embodiments, a drafter may selectively return to a prompt that has a response and choose a different response. During negotiation, a reviewer may choose a different response, which in turn may select different text to insert into the draft document. In various embodiments, a selected response for a drafter may be displayed in one style, while a selected response for a reviewer may be displayed in another style. The styles may affect one or more attributes such as the size, shape, color, highlight, underline, font, or other attribute of the text at issue. In this way, drafters and reviewers may be provided with visual cues as to areas of disagreement in the document and which party has taken which position.

For example, where there is disagreement on a part of the document, the system may present the document text associated with that disagreement presented by the drafter in a blue font, and the text associated with that disagreement presented by the reviewer in a yellow font. There may be a third style applied when opposing parties agree on a response. The third style may be different from the first style and from the second style. For example, the system may present document text in a green font when both parties agree on document text.

Response component 114 may also be configured to receive one or more responses associated with one of the prompts. Received responses may be stored in electronic storage 130. Response component 114 may also be configured to present a manager with a selection of response types. Response types may include discrete response choices (e.g., selection of radio buttons or drop-down-menu items) and/or manual input (e.g., keyboard entry). Response types may be associated to one of the prompts. Response types may be used in the responses presented to the drafter.

Listener component 116 may be configured to compile and/or execute the listeners. Listeners may include listener conditions and listener actions. One or more listeners may be associated to one or more of the prompt sections, prompts, responses, and other components of the system. Listener conditions may use Boolean logic, multivariable logic, and other logic to respond to responses received from a user. When a particular response is received, one or more listeners associated with the received response may execute to fulfill the templates instructions as configured in manager interface component 124 for creating a document. For example, listeners can be associated with document segments such that when a listener is invoked its associated segment or segments can be included in, or excluded from, the document being created. Accordingly, listener actions may include adding, removing, and/or modifying a segment in the document. As a simple example, assume a drafter of an agreement is prompted to select whether the agreement is not assignable, freely assignable, or assignable under certain conditions. Further assume the drafter responds that the agreement is not assignable. In this case, segments of document text associated with free assignability and assignability under certain conditions may be deleted from the document, and the segment of text regarding non-assignability is retained. Listeners may also affect other functions of the system as well. For example, when a listener is invoked as part of a response and makes changes to the document, the listener can also update the table of contents to correspond to the document changes. As also described herein, listeners may apply grammatical logic to update grammatical and stylistic changes to the document based on responses received or other changes made to the document. Listeners may also be configured to determine the appropriate portion of the document to be displayed to the user, what prompts and responses are displayed, how the document is displayed, how segments are displayed, how edits are recorded and/or distributed, and/or other functions.

Listeners can also be associated with other prompts and responses in the document template. For example, a particular response to a prompt may lead to a condition in which further prompts relating to that topic are not required. In this case, a listener may alter the document template such that these further prompts are not presented to the user. Consider again the example above in which the drafter is prompted to respond whether the document is not assignable, freely assignable, or assignable under certain conditions. Where the drafter selects a response that the agreement will be assignable under certain conditions, the listener may cause the template to present further prompts that prompt for responses regarding assignability conditions. For example, a further prompt may include a prompt to query the drafter whether the agreement should be assignable in the event of a change of control, assignable with consent of the other party, and so on. Continuing with this example, where the drafter selects a response that the agreement will not be assignable under any circumstances, any further prompts regarding assignability may be bypassed.

As these examples illustrate, actions may include hiding or revealing certain prompts and their associated responses. As these examples also illustrate, selecting a particular response to a prompt may affect the use of a concept throughout an entire document. One or more listeners may delete all references to the concept throughout the document, navigate to certain portions of the document, hide one or more prompts, reveal one or more prompts, remove or include entire sections or portions of sections of the document, remove or include segments of the document, and/or other operations. In some embodiments, executing listeners may include determining if a listener condition is satisfied. If the listener condition is satisfied, the listener action may occur.

Listener component 116 may also be configured to facilitate creating listeners for a document template by the manager. The created listeners may be used in the drafter interface, such that one or more received responses may satisfy a created listener condition as described above.

Document component 118 may be configured to dynamically modify the document based on responses. In applications using listeners, the document can be modified by the execution of listeners in response to received responses. If a listener condition is satisfied, a listener action may modify the document such that a segment associated with the response is included in the document and segments associated with non-selected responses are excluded. For example, a segment associated with the response may be added or retained in the document. As another example, the document may include all possible segments and the listener may be configured to delete those segments associated with the responses not selected and retain only the segment associated with the selected response.

In various embodiments, the associated segment may be adapted to fit surrounding text such that it conforms with grammar rules, style rules, and/or other document structure. This adaption may be accomplished through the programmatic application of grammar rules. For example, consider a section of a document that includes a series of segments denoted by outline indicators such as romanettes, in which the segments are separated by punctuation such as commas, and the segments are joined by a conjunction such as “and.” Based on responses, segment may be adapted to include the appropriate romanette for an added segment and appropriate punctuation to separate segments. The system may also be configured to include the selected conjunction automatically before the last segment in the series, and to automatically update the outline indicators and punctuation, and move the conjunction if needed, when segments are added to or deleted from the series. In some embodiments, the associated segment may be adapted to the document such that selecting one or more responses to one or more prompts may remove, add, and/or modify one or more references to one or more segments made elsewhere in the document.

Recording component 120 may be configured to record one or more selected responses to the individual ones of the one or more prompts on the graphical drafter interface. A recorded response may be provided for display on a graphical drafter interface of a party. A party may be comprised of one or more drafters that are associated in some fashion related to the document. For example, a party may be a law firm, a company, and or any other group of people on the same team participating in the negotiation of a document (e.g., an agreement). Following this example, another party may be a law firm, company, or other group of people on the same team on the other side of the negotiation.

In various embodiments, all responses selected by one or more drafters of a given party may be recorded such that all other (or selected other) drafters of that party may see what responses were selected or what other revisions were made by that party's drafters. In some embodiments, these revisions by a party may be maintained internal to that party until that party has reached consensus on its revisions and releases a revised draft to the other party. Accordingly, the other party may be precluded from viewing one or more recorded responses until the document is sent to the other party. For example, recording responses or revisions made by the first party, to allow the first party to work collaboratively with its various drafters on a response.

Recording component 120 may also be configured to record one or more edits made to the document through a graphical drafter interface. Recorded edits may be provided for display on a graphical drafter interface to the drafter or to other members of the drafter's party. In some embodiments, recording the one or more edits may allow one or more other drafters from the drafter's party to review and collaborate on the document internally.

Distribution component 122 may be configured to distribute the document to the various users. For example, the distribution component 122 may be configured to send a released draft to the other party—e.g., a completed first draft from the drafter to the reviewer, or a completed, revised draft with an issues list from one party to the other party. The completed draft may include the text of the document as well as, in some cases, the prompts and responses that led to the draft.

When a party receives a distributed draft, the draft and appropriate responses may be displayed to the receiving party (e.g., a reviewer receiving a first or revised draft from a drafter, or the drafter receiving a revised draft from a reviewer). Displaying the draft may include displaying one or more selected responses to selected parties and drafters through their respective interfaces. In various embodiments, distributing responses may include providing for displaying some of the one or more selected responses to the parties through their respective interfaces along with the text of the document. For example, one or more responses selected by a first drafter and the accompanying text associated with those responses may be displayed such that members of the party reviewing this draft see the draft and the responses, and the team may collaborate on the draft. Then, once the draft is completed by this team effort, the team may send the response to the other side. As another example, responses may be shared with other parties so that some level of collaboration can occur before the official draft is sent.

Manager interface component 124 may be configured to generate a manager interface. A manager interface may include a table of contents component and a template prompt holder. The table of contents component may help facilitate the creation of a document navigator based on manager input in a prompt section field. As noted above, the table of contents for the document may be created and updated based on responses received to the various prompts. For example, where a response to a prompt indicates that a certain section should be included in the document, that section can be correspondingly added to the table of contents. The template prompt holder may contain all the prompt sections associated with one of the templates.

Segment component 126 may be configured to provide one or more segments, which may be maintained in some embodiments, in electronic storage. Electronic storage 130 may include an organized body of related information, according to some embodiments. In various embodiments, electronic storage 130 may include a series of segments that include tags so the segments can be associated with one or more responses to the prompts. The segments electronic storage 130 can also include boilerplate segments that are included regardless of particular responses to prompts. Segment component 126 may also be configured to obtain, from electronic storage 130, one or more segments.

Segment component 126 may also be configured to associate, or store an association of, one or more of the segments with individual one or more of the prompt sections. In some applications, this can be accomplished by a manager generating a document template so that the appropriate segments can be linked to their respective responses. Associating the one or more segments with one of the prompt sections may affect how one or more listener actions dynamically modify the document during document creation.

In some embodiments, server(s) 102, client computing platform(s) 104, and/or external resources 128 may be operatively linked via one or more electronic communication links. For example, such electronic communication links may be established, at least in part, via a network such as the Internet and/or other networks such as local installations, internal networks or distributed networks. It will be appreciated that this is not intended to be limiting, and that the scope of this disclosure includes embodiments in which server(s) 102, client computing platform(s) 104, and/or external resources 128 may be operatively linked via some other communication media.

A given client computing platform 104 may include one or more processors configured to execute computer program components. The computer program components may be configured to enable a manager or drafter associated with the given client computing platform 104 to interface with system 100 and/or external resources 128, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 128 may include sources of information outside of system 100, external entities participating with system 100, and/or other resources. In some embodiments, some or all of the functionality attributed herein to external resources 128 may be provided by resources included in system 100.

Server(s) 102 may include electronic storage 130, processor(s) 132, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 130 may comprise non-transitory storage media that electronically stores information. The electronic storage media of electronic storage 130 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 130 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 130 may include one or more virtual storage resources (e.g., cloud storage, a virtual private network, and/or other virtual storage resources). Electronic storage 130 may store software algorithms, information determined by processor(s) 132, information received from server(s) 102, information received from client computing platform(s) 104, and/or other information that enables server(s) 102 to function as described herein. Distributed computing applications may also be included as storage and application hosting leverage non-distributed computing platforms, such as, but not limited to, Etherium in the form of Decentralized Application or Autonomous Organizations, as well as other decentralized applications hosted within the block chain, or private block chain networks.

Processor(s) 132 may be configured to provide information processing capabilities in server(s) 102. As such, processor(s) 132 may include one or more of a digital processor, an analog processor, a digital circuit designed to process information, an analog circuit designed to process information, a state machine, and/or other mechanisms for electronically processing information. Although processor(s) 132 is shown in FIG. 1 as a single entity, this is for illustrative purposes only. In some embodiments, processor(s) 132 may include a plurality of processing units. These processing units may be physically located within the same device, or processor(s) 132 may represent processing functionality of a plurality of devices operating in coordination. Processor(s) 132 may be configured to execute components 108, 110, 112, 114, 116, 118, 120, 122, 124, 126, and/or other components. Processor(s) 132 may be configured to execute components 108, 110, 112, 114, 116, 118, 120, 122, 124, 126, and/or other components by software; hardware; firmware; some combination of software, hardware, and/or firmware; and/or other mechanisms for configuring processing capabilities on processor(s) 132. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, 122, 124, and 126 are illustrated in FIG. 1 as being implemented within a single processing unit, in embodiments in which processor(s) 132 includes multiple processing units, one or more of components 108, 110, 112, 114, 116, 118, 120, 122, 124, and/or 126 may be implemented remotely from the other components. The description of the functionality provided by the different components 108, 110, 112, 114, 116, 118, 120, 122, 124, and/or 126 described below is for illustrative purposes, and is not intended to be limiting, as any of components 108, 110, 112, 114, 116, 118, 120, 122, 124, and/or 126 may provide more or less functionality than is described. For example, one or more of components 108, 110, 112, 114, 116, 118, 120, 122, 124, and/or 126 may be eliminated, and some or all of its functionality may be provided by other ones of components 108, 110, 112, 114, 116, 118, 120, 122, 124, and/or 126. As another example, processor(s) 132 may be configured to execute one or more additional components that may perform some or all of the functionality attributed below to one of components 108, 110, 112, 114, 116, 118, 120, 122, 124, and/or 126.

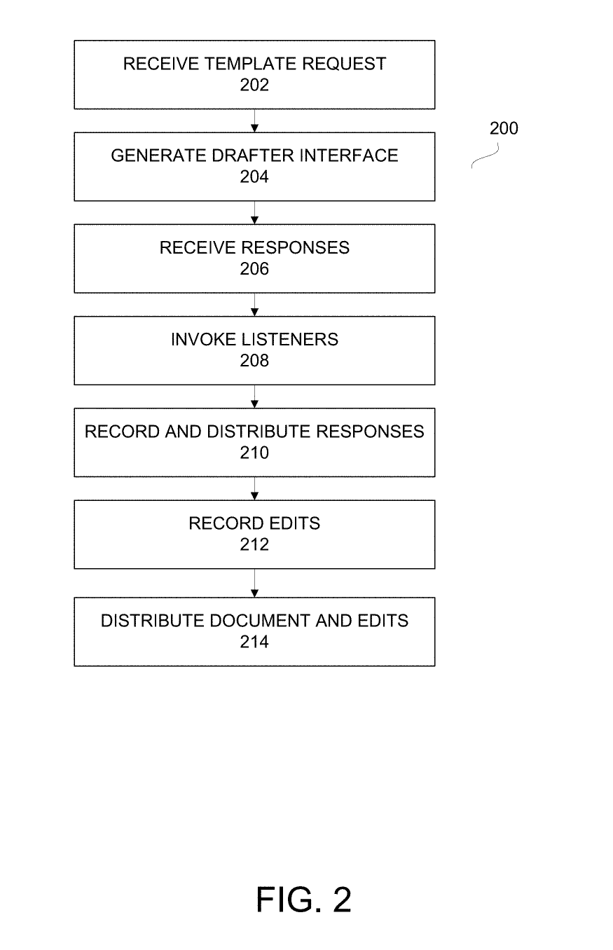

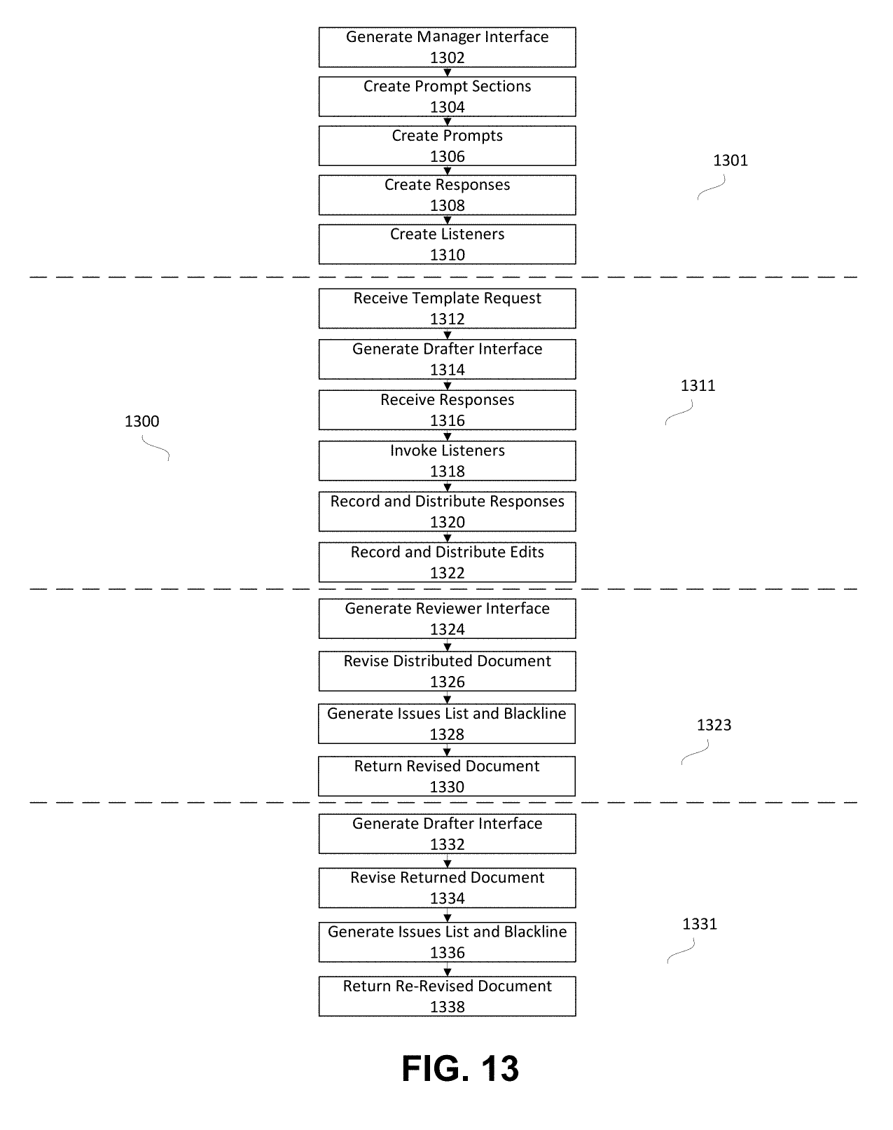

FIG. 13 illustrates a method 1300 for creating a dynamically editable document template and for reviewing, drafting, negotiating, and finalizing a dynamically editable document, in accordance with one or more embodiments. The operations of methods 1300, 200, and 300 presented below are intended to be illustrative. In some embodiments, methods 1300, 200, and 300 may be accomplished with one or more additional operations, and/or without one or more of the operations discussed. Additionally, the order in which the operations of methods 1300, 200, and 300 are illustrated in FIGS. 1300, 2, and 3 described below are not intended to be limiting.

In some embodiments, methods 1300, 200, and 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods 1300, 200, and 300 in response to instructions stored electronically on an electronic storage medium. The one or more processing devices may include one or more devices configured through hardware, firmware, and/or software to be specifically designed for execution of one or more of the operations of methods 1300, 200, and 300.

Referring now to FIG. 13, this example process includes processes 1301, 1311, 1323, and 1331. Process 1301 illustrates an example process for creating a dynamically editable document template (e.g. document template 1204). This process for creating a document template includes generating a manager interface (operation 1302). An operation 1304 may include creating prompt sections. In one embodiment, this can include identifying the sections of the document that will be included in the dynamically editable document, and creating a series of segments for one or more of the identified sections. For example, the manager creating the document template may include segments for a number of different possible positions that might be taken in the document. Consider again the example of a section for assignment provisions of an agreement. The manager may include a segment stating that the agreement is not assignable, a segment stating that the agreement is freely assignable, and one or more segments providing different types of conditions upon which an agreement might be assignable. This can be done for multiple sections in the document such that a universe of realistic possibilities for drafting a document from the document template are included in the compilation of segments provided. Although this embodiment describes creating a document template from scratch, in other embodiments, a previously created document template can serve as the starting point for a new document template.

An operation 1306 may include creating prompts for the document template. Prompts may be created to provide queries or other prompts to the drafter and reviewer to allow them to provide responses that will be used to build sections of the document. As described above, prompt creation can include creating prompts of various prompt types, associating prompts with sections of the document, and so on.

An operation 1308 may include creating predefined responses to the prompts. As noted above, in creating the document template, the manager can provide prompt language for radio buttons, drop-down menu items, or other predefined responses that can be selectable by the drafter or reviewer in creating and negotiating the document. The responses created can also include other fields such as, for example, document blanks, lists, complex lists, or text entry fields.

An operation 1310 may include creating listeners for the document template. As described above, one or more listeners can be associated with one or more responses, and the one or more listeners may be executed in response to a user response. Execution of the listener may result in the inclusion of one or more predefined segments in a document, the exclusion of other segments from the document, a change to prompts provided to a user, and so on.

Method 1311 illustrates an example method for drafting a dynamically editable document. At operation 1312, a template request may be received from a document drafter representing the type of document the drafter wishes to create. For example, the drafter might request a settlement agreement type from which the drafter will create a draft settlement agreement.

At operation 1314 the system may generate a drafter interface to the drafter. In various examples described herein, the drafter interface may present to the drafter prompts and possible responses, and document text that will be dynamically edited as responses are made to the prompts. The drafter can then review the prompts and provide responses to the prompts. As described herein, in some instances the responses can be user selections from pre-determined responses such as radio-button selections or drop-down menu selections, text entry, or other response types. In some embodiments, responses are entered one at a time and the system acts on each response as it is received. In other embodiments, multiple responses can be provided to the system. Consider again the context of a settlement agreement. In this example, a prompt may ask the drafter whether there will be dismissal of a lawsuit associated with the settlement agreement. The prompt can provide yes and no responses. If a yes response is made, a further prompt may ask whether this dismissal is with prejudice or without prejudice.

At operation 1316 the system receives the responses provided by the drafter. The system reacts to the responses by updating the document being created. This can be accomplished, for example, by invoking listeners as illustrated at operation 1318. Execution of the listeners may result in modifying the document, such that the updated document text may be displayed to the drafter on the drafter interface. At operation 1320, the responses may be recorded and distributed. Continuing with the example of a prompt regarding dismissal of a lawsuit, assume the user selected ‘yes’ as a response. In this case, a further prompt may be provided asking for a case number in case name by which the case may be identified. Another prompt may be provided asking whether the drafter whether the settlement agreement will require that the case be dismissed with prejudice or without prejudice. These responses may be recorded such that a first party may be able to see the responses. In some embodiments, these responses may be distributed, such that all parties may see the responses.

In addition to responding to prompts, the drafter can also update segments within the text manually via the drafter interface. When the drafter is satisfied that the draft document is complete and ready to send to the opposing party for review, the drafter may, via the drafter interface, cause the document to be sent. At operation 1322 the system distributes the modified document and any edits made by the drafter. In some embodiments, the completed document may be distributed to or reviewer for review, while in other embodiments the completed document may be the final document and not subject to further review.

Method 1323 illustrates an example method for reviewing and revising a dynamically editable document template. The reviewing party receives the document from the drafting party and a reviewer opens the document. At operation 1324 the system generates the document to the reviewer via a reviewer interface. The reviewer interface may be configured like the drafter interface and may include prompts and responses as well as text of the document being reviewed.

An operation 1326 may include revising a distributed document. For example, the reviewer may be given similar prompts as the drafter so that the reviewer can create a document according to his or her requirements. Continuing with the example of a settlement agreement, the reviewer may also be given a prompt allowing the user to select whether there is a case to be dismissed, and if so, whether it should be dismissed with or without prejudice. The reviewer can respond to prompts, and also edit the document text to make revisions.

An operation 1328 may include an issues list and blackline reflecting edit changes to the text of the draft document. The issues list can include a listing of areas of disagreement in the document. For example, the drafter may have selected a response that the lawsuit should be dismissed with prejudice and edited the text of the response, while the reviewer selected a response that the lawsuit should be dismissed without prejudice. In this case, this disagreement may be added to the issues list, and the reviewer's edits to the text of the response may be shown in blackline form. In some embodiments, the text associated with the disagreement can be shown in different styles as described above to highlight the area of this agreement. For example, the issues list may include the drafter's position in blue, the reviewer's position in yellow, and any agreed upon positions in green, although other styles may be used.

When the reviewer and the reviewer team is satisfied that the revised document can be returned to the drafter, the reviewer can, via the reviewer interface, cause the document to be transmitted. At operation 1330, the system returns the revised document. If the reviewer has no changes or revisions to the document, the process may be finalized.

Method 1331 illustrates a method for the original drafter reviewing and revising a dynamically editable document. The drafter receives the document and opens it. At operation 1332 the system generates the document to the drafter via the drafter interface. Because it is a document received for review, the reviewer interface may be different from the drafting interface. Because the drafter is now technically reviewing and revising the document, (rather than initially drafting it) the process that occurs can be similar to that which is described above with reference to process 1323. Accordingly, operation 1334 may include the drafter reviewing and revising the revised document. In the event the reviewer made changes, these changes are shown to the drafter in blackline form and an issues list is provided to the drafter via the drafter interface.

If the drafter has additional changes he or she would like to make to the reviewer's turn of the document, an operation 1336 may include updating the issues list and blackline. When the drafter is satisfied with the changes he or she has made, the drafter can cause, by the drafter interface, the revised document to be sent to the other party. Therefore, at operation 1338 the system made the revised document to the reviewer for review and possible further revisions.

Methods 1323 and 1331 may be repeated until a document is finalized, or agreed upon by the parties.

FIG. 2 illustrates an example method 200 for drafting a dynamically editable document. An operation 202 may include receiving a template request. For example, a template request may include a request for a document that a drafter is going to draft. Examples of documents in the legal field can include a non-disclosure agreement, a licensing agreement, an indemnity agreement, a non-compete agreement, a purchase agreement, an independent contractor agreement, a settlement agreement and/or other documents. The template document may include one or more segments and/or other text. In some embodiments, the template includes all spans associated with all possible pre-defined responses to the prompts, where such responses can be predefined as a segment. In such cases, the template document may be a lengthy compilation of document sections with each segment included.

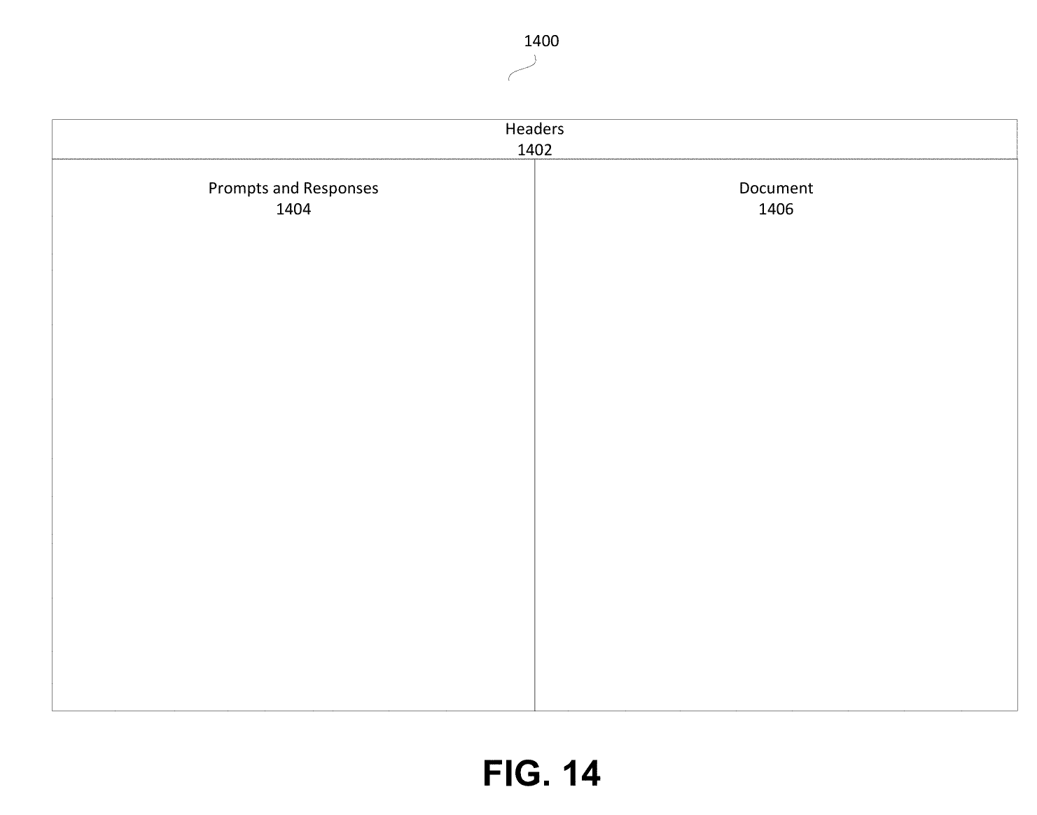

An operation 204 may include generating a drafter interface and presenting the drafter interface to the drafter. In some embodiments, a drafter interface may include some or all of a set of prompts, a document, a document navigator interface, an issues list interface, a prompt view interface, a blackline interface, and an edit interface. An example of a drafter interface is illustrated in FIG. 14. In this example, headers 1402 are provided near the top of drafter interface 1400. Although not illustrated, the header interface may include a document navigator (described in more detail below), an issues list (described in more detail below), a prompt view (described in more detail below), a blackline view (described in more detail below), and an edit view (described in more detail below). Prompts and responses 1404 may be provided on the left hand side of drafter interface 1400, and document 1406 may be presented on the right hand side of drafter interface 1400. The document may include document text, segments, and/or other information.

The drafter interface presents a set of prompts to the drafter. The prompts may include questions, queries, commands, and other prompts, and may be associated to a prompt section. A prompt section may be associated to a section of the document and to a section in the document navigator interface.

A document navigator interface may also include a dynamic table of contents. The table of contents may be populated with prompt sections and associated sub-sections. The prompt sections may be selected such that the associated prompts are displayed on the drafter interface and the associated portion of the document is displayed on the drafter interface. The document navigator is also updated in the event that certain segments are not included in the document.

An issues list interface may include all points of disagreement between opposing parties involved with a document. The points of disagreement may include different responses to one or more of the prompts, as well as any edits of any segments from an opposing party. If an opposing party makes any edits, and the edits are not revised upon sending the document back to the opposing party, the edits may be taken off the issues list interface.

A blackline interface may preserve and compile the historic record of all edits to the document, such that a user (a drafter or a reviewer) may be able to compare various points in the document history against any other points in the document history. In some embodiments, each edit must be accepted or rejected by the first party before it can be sent to an opposing party. An immutable historic record may be kept of the document as the document is exchanged between opposing parties. When the document is sent to the opposing party, the opposing party may see all the edits made on that round of negotiating the document.

An edit interface may be displayed on the drafter interface such that a party may edit the text on the draft. The edit interface may allow a drafter to make more granular changes to the document, such as modifying punctuation, a letter, a number, a word, and/or other text. A first drafter's edits may be displayed in a first style. A second drafter's edits may be displayed in a second style. The first drafter and the second drafter may be from a first party. The first drafter and the second drafter may be from opposing parties. A first style may be different than a second style. The first style may be a different size, shape, color, highlight, underline, font, and/or other difference than the second style.

At operation 206, the system receives responses to the prompts. Responses may include, for example, selections of radio buttons or drop-down menu items, answers to prompts, responses to fill-in-the-blank prompts and so on. The drafter (or reviewer in the case of document revision), responds to the prompts in the sequence provided. As described below, the system uses the responses to build the document (e.g., by selecting or retaining segments associated with the response) and may also alter subsequent prompts based on the response. The received responses may be stored in electronic storage.

An operation 208 may include invoking listeners based on the responses. In some embodiments, one or more listeners are associated with a response. When a response is received, its associated listener(s) may be invoked and the listener acts on the document. For example, a listener may act to retain all document segments associated with a selected response and to delete all document segments associated with the responses that were not selected. In this way, the document can be built from the segments corresponding to the drafter responses. Accordingly, listener actions may include adding, removing, and/or modifying a segment in the document. Listener actions may further include hiding, revealing or altering subsequent prompts and response options. Listener actions may also include otherwise affecting prompts, responses, and/or the document.

Invoking listeners may include modifying the document. As described immediately above, the document may be modified based on the listener action. This operation may also include dynamically making any grammatical changes appropriate based on the document modification, such as appropriately placing or removing an oxford comma or semicolon, renumbering a list of items, relocating a conjunction, or other grammatical/stylistic adjustments. The modified document may be presented to the drafter on the drafter interface in real time as the document is modified based on responses.

An operation 210 may include recording and distributing responses. Recorded responses may be available for all users of a first party associated with the document. Distributed responses may be available for all parties and users associated with the document. An operation 212 may include recording edits. Recorded edits may be available for all users of a first party associated with the document. An operation 214 may include distributing the modified document and the edits. Distributed edits may be available for all parties and users associated with the document. The distributed document may be available for all parties and users associated with the document.

This process of providing prompts, receiving drafter responses and updating the document based on the responses may be repeated until the draft document is ready for review by an opposing party. Once the draft is finished to the drafter's satisfaction, the drafter may then send the dynamically editable document to the reviewer (e.g., the opposing party), and the reviewer may revise the document. This may begin the negotiation process as document versions are passed back and forth between the drafter and the reviewer.

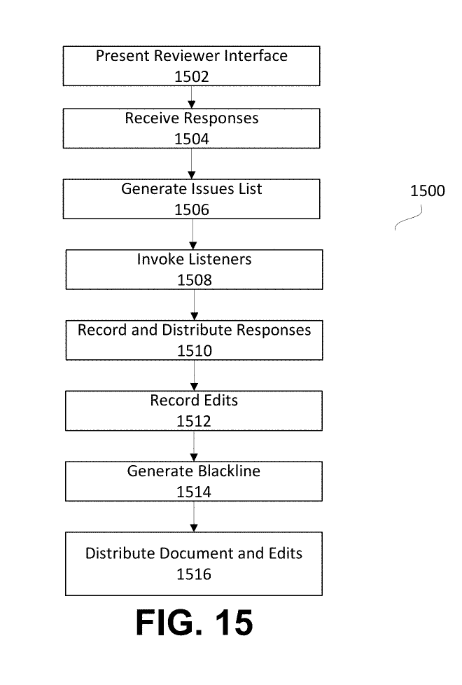

FIG. 15 illustrates an example method 1500 for reviewing and negotiating a dynamically editable document. This process can be carried out, for example, by the reviewing party when it receives a draft from the drafting party or by the drafting party when it receives a revised draft back from the reviewing party. In other words, after a drafter has completed and sent the first draft, the processes invoked may be similar or the same as the parties review and revise the document in an effort to reach agreement on all points.

An operation 1502 may include generating a reviewer interface and presenting the reviewer interface to the reviewer. The reviewer interface may include some or all of a set of prompts, a document, a document navigator interface, an issues list interface, a prompt view interface, a blackline interface, and an edit interface. The reviewer interface may be substantially the same as drafter interface of FIG. 2. The reviewer interface may include the document distributed by the drafter and include the drafter's responses.

An operation 1504 may include receiving responses. Responses may include, for example, selections of radio buttons or drop-down menu items, answers to prompts, responses to fill-in-the-blank prompts and so on. Operation 1504 may be substantially the same as operation 206 of FIG. 2. The reviewer may also key in changes directly to the document text such as, for example, by inserting, deleting or editing text.

An operation 1506 may include generating an issues list. The issues list may include all points of disagreement between the drafter and the reviewer. The points of disagreement may include different responses to one of the prompts, as well as any edits from the reviewer in the distributed document. For example, if the drafter makes a first set of edits and sends the document to the reviewer, the first set of edits may appear on the issues list. If the reviewer sends the document back to the drafter and does not change the first set of edits made by the drafter, the first set of edits may be removed from the issues list.

An operation 1508 may include invoking listeners. When a response is received, its associated listener(s) may be invoked and the listener acts on the document. For example, a listener may act to retain all document segments associated with a selected response and to modify/delete all document segments corresponding to the responses that were not selected. In this way, the document can be built from the segments corresponding to the drafter responses. Accordingly, listener actions may include adding, removing, and/or modifying a segment in the document. Listener actions may further include hiding, revealing or altering subsequent prompts and response options. Listener actions may also include otherwise affecting prompts, responses, and/or the document. Listeners may be substantially the same as listeners and operate in the same manner as the listeners discussed in FIG. 2.

Invoking the listeners may include modifying the distributed document. The document may be modified by the listeners. This operation may also include dynamically making any grammatical changes appropriate based on the document modification, such as appropriately placing an oxford comma, renumbering a list of items, relocating a conjunction, or other grammatical/stylistic adjustments. The modified document may be presented to the reviewer on the reviewer interface in real time as the document is modified based on responses and listeners. This may be done in substantially the same fashion described in FIG. 2.

An operation 1510 may include recording and distributing the reviewer's responses. Recorded responses may be available for all users of a first party associated with the document. Distributed responses may be available for all parties and users associated with the document. Recording and distributing may be done simultaneously or separately.

An operation 1512 may include recording edits. This may be done in the edit interface. As discussed in FIG. 2, the edit interface may allow the reviewer to make more granular changes to the document, such as modifying punctuation, a letter, a number, a word, and/or other text. The reviewer may alter the distributed document. Recorded edits may be available for all users of a first party associated with the document.

An operation 1514 may include generating a blackline. This may include a preserved history of all distributed edits to the document. In some embodiments, each edit must be accepted or rejected by the first party before it can be sent to an opposing party. An immutable historic record may be kept of the document as the document is exchanged between opposing parties. When the document is sent to the opposing party, the opposing party may see all the edits made on that round of negotiating the document.

For example, a first drafter from a first party may be able to compare earlier recorded responses and edits to the document against the later recorded responses and edits to the document after it was distributed by a second drafter from a second party back to the first drafter from the first party, wherein the second party is an opposing party to the first party. A first drafter from the first party may also be able to compare the first drafter's current recorded responses and edits against earlier recorded responses and edits to the document distributed by a second drafter from a second party. The first drafter may be able to compare the current recorded responses and edits to other recorded responses made by the first drafter. A drafter may also be able to compare the drafter's current recorded responses to the first document drafted by the drafter. The drafter may be able to compare various other points in the document history against any other points in the document history.

An operation 1516 may include distributing the revised document and edits to the drafter. The reviewer may also be a drafter. The distributed document may be available for all parties and users associated with the revised document. Distributed edits may be available for all parties and users associated with the revised document. As the document is passed back and forth between opposing parties, the document may be reviewed and negotiated. Eventually, a finalized document may emerge. The finalized document may be fully agreed upon by both parties.

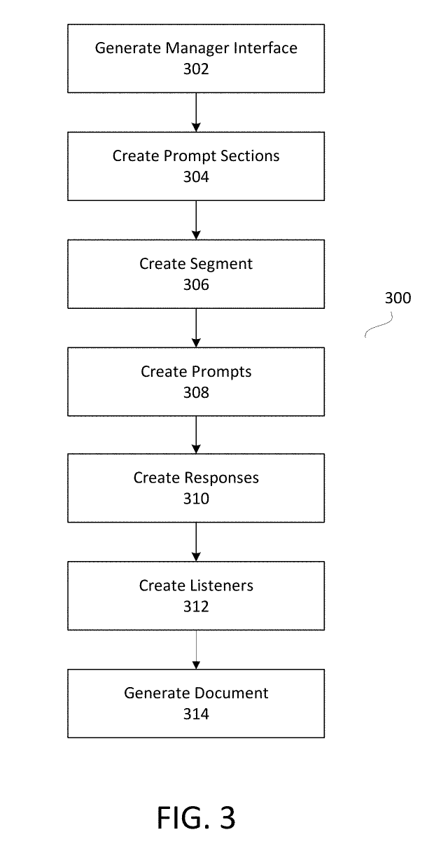

FIG. 3 illustrates an example method 300 for creating a dynamically editable document template. An operation 302 may include generating a manager interface. The manager interface may be presented to a manager. The manager may create dynamically editable document templates for the drafter. The manager interface may include a table of contents component and a template prompt holder. The manager interface may help create the dynamically editable document template selected by the drafter. The table of contents component may set up the document navigator based on manager input in a prompt section field. A template prompt holder may contain all the prompt sections for the template. The manager interface may also include prompt section fields, segment fields, prompt fields, response fields, and listener fields.

An operation 304 may include creating prompt sections. The prompt section field may allow for manager input, such that the manager's input will be used in presenting a prompt section to the drafter. Based on the manager's input, the table of contents in the document navigator may be set up. For example, if a manager labels one of the prompt section fields “Confidentiality,” the drafter may come across prompts and portions of the document that are associated with the section labeled “Confidentiality.” Labeling a prompt section field may also include the labeled prompt section field in the table of contents in the document navigator in the drafter interface. Continuing the example above, “Confidentiality” may be presented to the drafter in the document navigator interface, such that the drafter may be able to select the prompt section. Selecting the prompt section may present prompts and portions of the document associated with the prompt section label.

An operation 306 may include creating a segment. The segment field may allow for manager input, such that the manager's input will be used in presenting a segment to the drafter. The segment may be associated to the labeled prompt section. The segment may include a span, a paragraph, a sentence, a word, a letter, a number, a symbol, an image, and/or any combination of visual content. The segment may be created in the manager interface such that the segment may include one or more spans. For example, a segment may be a paragraph within the document. A given segment may be the paragraph, a sentence within the paragraph, a word within the paragraph, and/or a letter, number, symbol, or other such text. The created segment may be presented to the drafter in one of the sections. For example, a created segment may be associated with the “Confidentiality” section. When the drafter enters the “Confidentiality,” the created segment may be added, removed, or modified based on the drafter's responses which execute listeners.

An operation 308 may include creating prompts. The prompt field may allow for manager input, such that the manger's input will be used in presenting a prompt to the drafter. The prompt field labeled by the manager may be associated with a prompt with the associated label in a prompt view. The prompt may include questions, queries, commands, and/or other prompts. The prompt may be associated to the labeled prompt section. For example, one of the prompt fields associated with the “Confidentiality” section may be labeled, “Must Confidential Information be limited to confidential, proprietary or non-public information?” The labeled prompt field may be presented to the drafter in the drafter interface. In particular, the drafter may be presented the labeled prompt field as one of the prompts in the “Confidentiality” section.

One of the prompt fields may include selecting a prompt type. The prompt type may include a yes or no prompt type, a multiple choice prompt type, a date field, a month counter, a year counter, a text field, and/or other prompt types. The prompt type may be associated to the prompt. The prompt type may affect the type of responses available to the drafter. The prompt type may be presented to the drafter. Continuing the example above, the prompt type for the prompt field labeled “Must Confidential Information be limited to confidential, proprietary or non-public information?” may be a multiple choice prompt type. Responses may be limited to a number of choices when presented to the drafter. Multiple choices may be selected by the drafter. The limited responses may be presented with the associated labeled prompt field.

An operation 310 may include creating responses. The response field may allow for manager input, such that the manger's input will be used in presenting a response to the drafter. Response fields may include one of the responses, text describing one of the responses, and/or a tag associated with a segment. Response fields may be associated with one of the prompt fields. Response fields may be affected by one of the selected prompt types. Response fields may be associated with responses. In some embodiments, if a prompt type is a text field, the response field may describe what type of text should be input in the text field. Continuing the example above, response fields associated with the multiple choice prompt type may include “Confidential Information,” “Proprietary Information,” and/or “Non-Public Information.” The choices may be presented to the drafter in responding to the prompt. The drafter may select one or more of the choices.

The response fields may also present a field for the manager to input a description of one of the responses. For example, a prompt field labeled “How many copies may the Disclosing Party retain?” may be associated with a response field stating “Fill in number of copies.” This response field is describing to the drafter how to fill in an associated text box.

The response fields may also present a field for the manager to input a tag associated with one of the segments. In some embodiments, a response field may use a tag associated to one of the segments, such that if the drafter uses the tag, the segment may be added, removed, or otherwise modified in the document. Continuing the example above, if a drafter input “15” copies, the tag associated with one of the segments may add “15” to a relevant portion of the document which is facilitated by the listener operation explained below.

An operation 312 may include creating listeners. Listeners may include listener conditions and listener actions. Listeners may be associated to one of the prompt sections. Listener conditions may use Boolean logic, multivariable Boolean theorems, and/or other logic. Listener conditions may depend on prompts and/or responses. When a listener condition is satisfied or not satisfied, a listener action may take place. For example, a listener condition may require that a first set of conditions or a second set of conditions is satisfied. If either set of conditions is satisfied, the associated listener action may occur. Listener conditions can be grouped infinitely to accommodate and accept multiple matching conditions based upon logic.

Listener actions may include adding, removing, and/or modifying one or more segments in the document. For example, if a no response is selected in a yes or no prompt type, the listener may remove one or more segments throughout the document.

Listener actions may also include hiding or revealing prompts and/or responses. For example, if a no response is selected in a yes or no prompt type, the listener may remove a subsequent prompt and/or response. Listener actions may also include otherwise affecting prompts, responses, and/or the document.

An operation 314 may include generating a drafter interface. A drafter interface may include a set of prompts and the document.

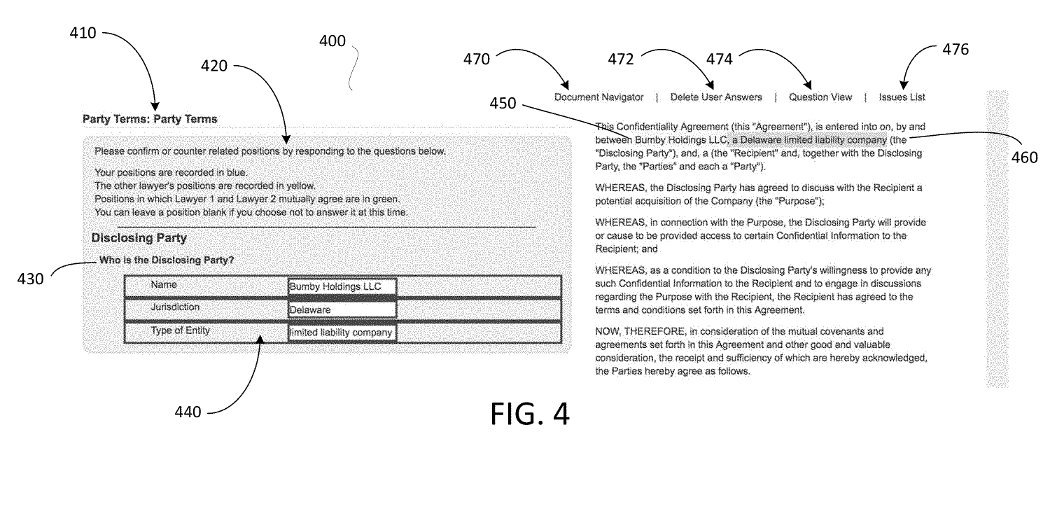

FIG. 4 illustrates an example view of an interface for drafting, reviewing, negotiating, and finalizing a dynamically editable document, in accordance with one embodiment of the technology described herein. FIG. 4 is shown in the context of an example document. Drafter interface 400 provides a prompt 430, text of the document 450 and headers 470, 472, 474, 476. Section 410 indicates which section a prompt belongs to. Instructions 420 tell the drafter (or reviewer as appropriate) what actions are to be taken to complete the document.

Prompt 430 in the case may be a prompt displayed to the drafter. Response 440 provides a field in which a response or responses can be selected or input. Response 440 in this example includes a text field for the drafter. Highlighted portions 450 and 460 show the document modified in real time based on the responses input by the drafter. Highlighted portion 460 indicates how the document may be modified based on the input of a jurisdiction.

Header 470 displays a Document Navigator link that may allow the drafter to selectively navigate a document based on the sections of the document in another portion of the graphical user interface. This is discussed in more detail above. Header 472 displays a Delete User Answers link that may allow the drafter to delete all selected responses to a document and start from the beginning. This is discussed in more detail above. Header 474 displays a Questions View link that may allow the drafter to view all the prompts in another portion of the graphical user interface. This is discussed in more detail above in reference to a prompt view interface. Header 476 displays an Issues List link that may allow the drafter to more easily compare points of disagreement between parties. This is discussed in more detail above.

FIG. 5 illustrates another example view of an interface for drafting, reviewing, and negotiating a dynamically editable document, in accordance with one embodiment of the technology described herein. Interface 500 in this example provides a list of responses to a prompt, with radio buttons allowing the drafter to select the appropriate criteria for each Party in the response. Highlighted portion 520 indicates how the document may be modified based on the example selections for the Parties. In this example, the romanette section headings may automatically adapt to the surrounding text when an entry is added, deleted, or modified. Button 530 allows the drafter to return to the previous prompt. Button 540 allows the drafter to continue to the next prompt.

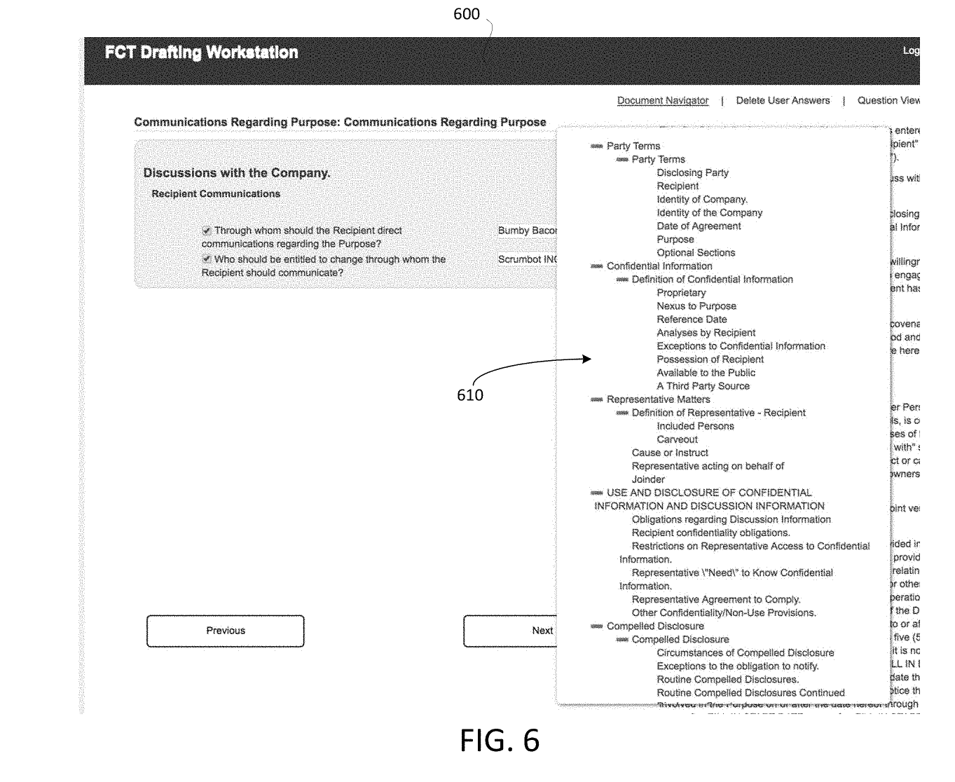

FIG. 6 illustrates another example view of an interface for drafting, reviewing, and negotiating a dynamically editable document, in accordance with one embodiment of the technology described herein. Interface 600 provides a document navigator interface over the document interface. Document navigator 610 displays a document navigator based on the list of sections and sub-sections of the document. It may allow the drafter to more easily access particular sections or sub-sections of a document by selecting one of the sections or sub-sections. The drafter may also minimize or expand a section and/or sub-section.

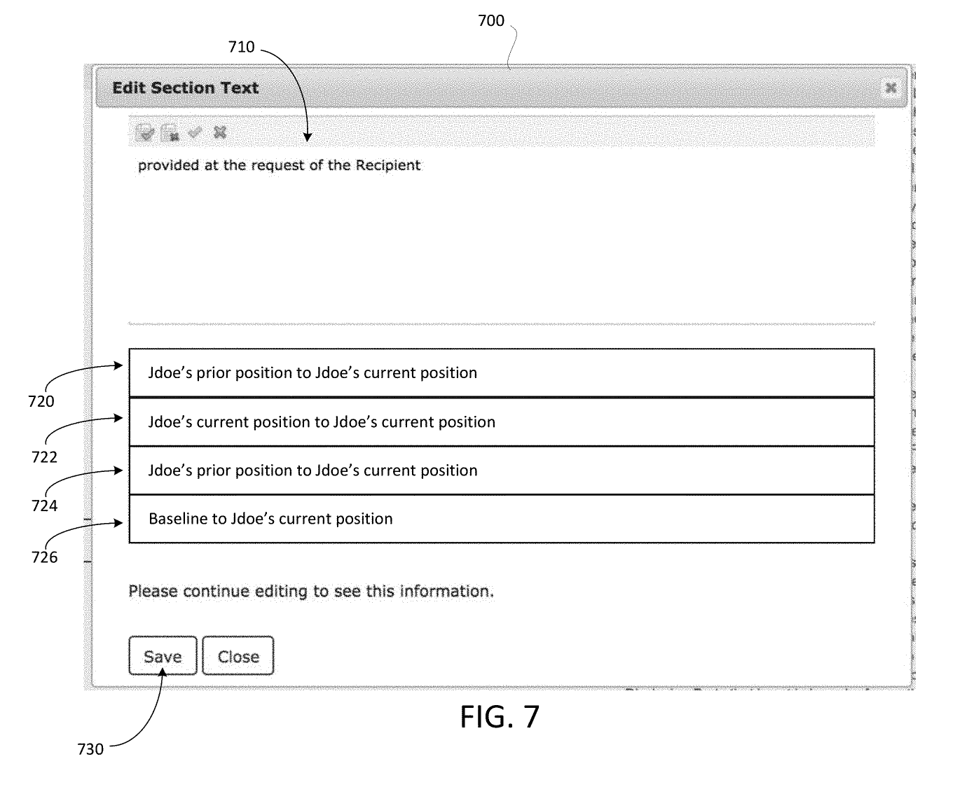

FIG. 7 illustrates an example view of an interface for drafting, reviewing, and negotiating a dynamically editable document, in accordance with one embodiment of the technology described herein. Interface 700 provides a place to edit text and compare various histories of the selected text. Input box 710 may be a dynamically editable area where the drafter can input text, images, symbols, and/or other input. Selection 720, 722, 724, and 726 indicate one or more ways to compare different histories of the selected text. Button 730 allows the drafter to record the edits made to the text. Button 732 allows the drafter to close the interface 700.

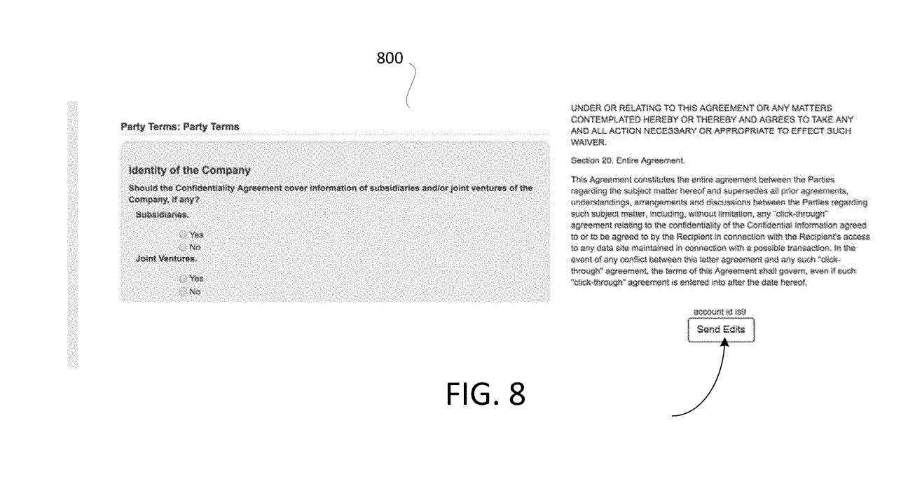

FIG. 8 illustrates a view of an example interface for drafting, reviewing, and negotiating a dynamically editable document, in accordance with one embodiment of the technology described herein. Interface 800 shows an example document interface that allows the drafter to distribute edits. Button 810 allows the drafter to distribute edits to all parties.

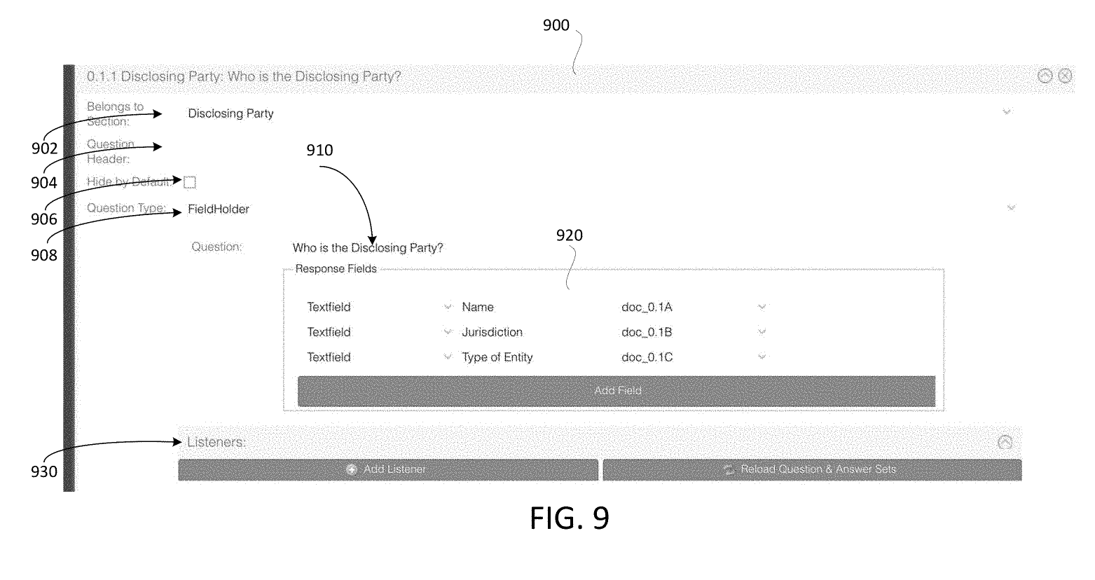

FIG. 9 illustrates an example view of an interface for creating a dynamically editable document template, in accordance with one embodiment of the technology described herein. Manager interface 900 may be presented to a manager. The manager may create the dynamically editable document templates. Interface 900 may provide a prompt template interface. Prompt section field 902 indicates what section the prompt may belong to. Prompt header field 904 indicates the prompt header. Field 906 provides a checkbox for whether this prompt may be hidden by default or not. Prompt type field 908 indicates the prompt type. Prompt field 910 indicates the prompt asked to the drafter. Interface 920 indicates the response fields associated with a response to the prompt. Response fields on the left of interface 920 indicate the required input from the drafter. Response field may display “Name” to indicate to the drafter that a name belongs in that space, “Jurisdiction” to indicate a jurisdiction belongs in that space, “Entity” to indicate an entity belongs in that space, and/or other inputs. The response fields on the right of interface 920 may generate segments based on the drafter's input. For example, inputting “doc_0.1A” may refer to a segment, or span, associated with that input, whose content may be modified. Header 930 may indicate a listener interface. A listener interface may allow modifications to the document based on conditions.

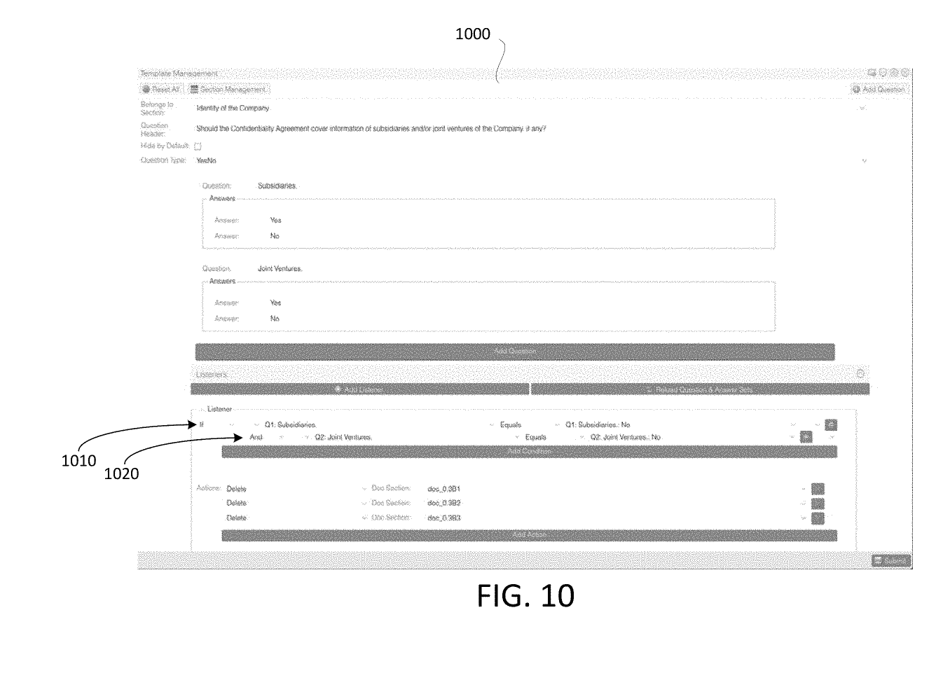

FIG. 10 illustrates an example view of a manager interface for creating a dynamically editable document interface, in accordance with one embodiment of the technology described herein. Interface 1000 may display a prompt template with a listener. Listener condition fields 1010 and 1020 may use Boolean operators to modify the document. Listener conditions may be grouped or nested so that multiple conditions may or may not be met to satisfy one or more conditions, such as multivariable Boolean computations. In particular, the listener actions may delete or add certain sections based on the drafter's selected responses. Other listener actions may be related to other prompts, answers, how individual prompts are related to individual answers, and what actions or modifications may take place based on the response fields. For example, a listener may add, remove, or otherwise modify one of the segments of the document. In another example, a listener may hide, reveal, or otherwise modify subsequent responses and/or prompts.

Although the present technology has been described in detail for the purpose of illustration based on what is currently considered to be the most practical and preferred embodiments, it is to be understood that such detail is solely for that purpose and that the technology is not limited to the disclosed embodiments, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

As used herein, the term set may refer to any collection of elements, whether finite or infinite. The term subset may refer to any collection of elements, wherein the elements are taken from a parent set; a subset may be the entire parent set. The term proper subset refers to a subset containing fewer elements than the parent set. The term sequence may refer to an ordered set or subset. The terms less than, less than or equal to, greater than, and greater than or equal to, may be used herein to describe the relations between various objects or members of ordered sets or sequences; these terms will be understood to refer to any appropriate ordering relation applicable to the objects being ordered.

The term tool can be used to refer to any apparatus configured to perform a recited function. For example, tools can include a collection of one or more components and can also be comprised of hardware, software or a combination thereof. Thus, for example, a tool can be a collection of one or more software components, hardware components, software/hardware components or any combination or permutation thereof. As another example, a tool can be a computing device or other appliance on which software runs or in which hardware is implemented.

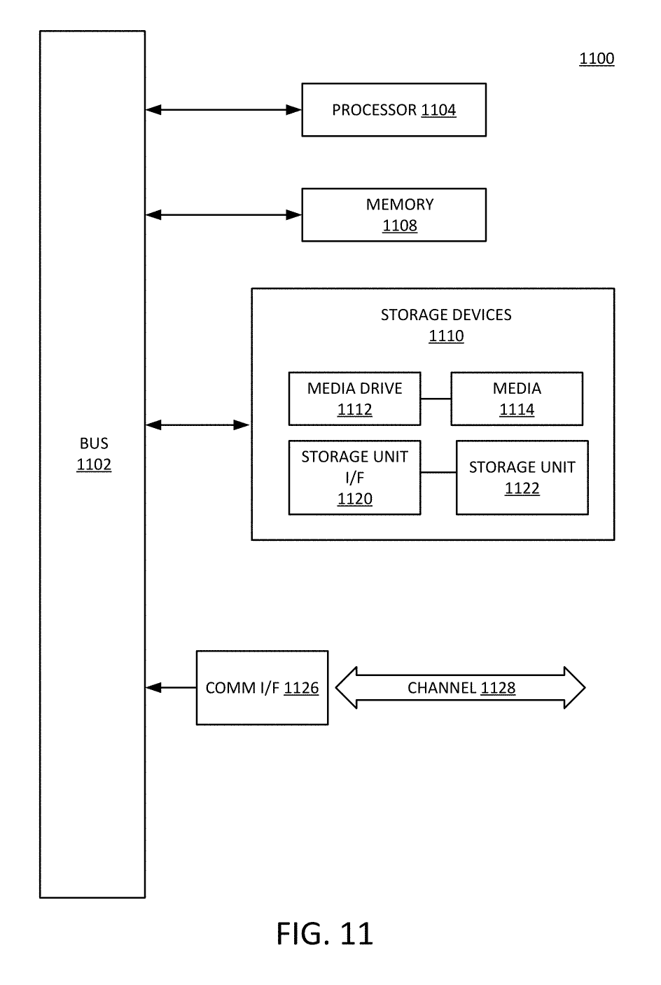

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. In other words, as would be apparent to one of ordinary skill in the art after reading this description, the various features and functionality described herein may be implemented in any given application and can be implemented in one or more separate or shared circuits in various combinations and permutations. Even though various features or elements of functionality may be individually described or claimed as separate circuits, one of ordinary skill in the art will understand that these features and functionality can be shared among one or more common circuits, and such description shall not require or imply that separate circuits are required to implement such features or functionality.

Where circuits are implemented in whole or in part using software, in one embodiment, these software elements can be implemented to operate with a computing or processing system capable of carrying out the functionality described with respect thereto. One such example computing system is shown in FIG. 11. Various embodiments are described in terms of this example-computing system 1100. After reading this description, it will become apparent to a person skilled in the relevant art how to implement the technology using other computing systems or architectures.

Referring now to FIG. 11, computing system 1100 may represent, for example, computing or processing capabilities found within desktop, laptop and notebook computers; hand-held computing devices (smart phones, cell phones, palmtops, tablets, etc.); mainframes, supercomputers, distributed applications (such as Etherium applications or private blockchain networks), distributed autonomous organizations, workstations or servers; or any other type of special-purpose or general-purpose computing devices as may be desirable or appropriate for a given application or environment. Computing system 1100 might also represent computing capabilities embedded within or otherwise available to a given device. For example, a computing system might be found in other electronic devices such as, for example, digital cameras, navigation systems, cellular telephones, portable computing devices, modems, routers, WAPs, terminals and other electronic devices that might include some form of processing capability.

Computing system 1100 might include, for example, one or more processors, controllers, control components, or other processing devices, such as a processor 1104. Processor 1104 might be implemented using a general-purpose or special-purpose processing engine such as, for example, a microprocessor (whether single-, dual- or multi-core processor), signal processor, graphics processor (e.g., GPU) controller, or other control logic. In the illustrated example, processor 1104 is connected to a bus 1102, although any communication medium can be used to facilitate interaction with other components of computing system 1100 or to communicate externally.

Computing system 1100 might also include one or more memory components, simply referred to herein as main memory 1108. For example, in some embodiments random access memory (RAM) or other dynamic memory, might be used for storing information and instructions to be executed by processor 1104. Main memory 1108 might also be used for storing temporary variables or other intermediate information during execution of instructions to be executed by processor 1104. Computing system 1100 might likewise include a read only memory (“ROM”) or other static storage device coupled to bus 1102 for storing static information and instructions for processor 1104.

The computing system 1100 might also include one or more various forms of information storage mechanism 1110, which might include, for example, a media drive 1112 and a storage unit interface 1120. The media drive 1112 might include a drive or other mechanism to support fixed or removable storage media 1114. For example, a hard disk drive, a floppy disk drive, a magnetic tape drive, an optical disk drive, a CD or DVD drive (R or RW), a flash drive, or other removable or fixed media drive might be provided, SQL/NOSQL data bases, and/or distributed data systems such as block chain ledgers or private block chain networks, distributed applications such as by not limited to Etherium hosted applications. Accordingly, storage media 1114 might include, for example, a hard disk, a floppy disk, magnetic tape, cartridge, optical disk, a CD or DVD, or other fixed or removable medium that is read by, written to or accessed by media drive 1112. As these examples illustrate, the storage media 1114 can include a computer usable storage medium having stored therein computer software or data.

In alternative embodiments, information storage mechanism 1110 might include other similar instrumentalities for allowing computer programs or other instructions or data to be loaded into computing system 1100. Such instrumentalities might include, for example, a fixed or removable storage unit 1122 and an interface 1120. Examples of such storage units 1122 and interfaces 1120 can include a program cartridge and cartridge interface, a removable memory (for example, a flash memory or other removable memory component) and memory slot, a flash drive and associated slot (for example, a USB drive), a PCMCIA slot and card, and other fixed or removable storage units 1122 and interfaces 1120 that allow software and data to be transferred from the storage unit 1122 to computing system 1100.

Computing system 1100 might also include a communications interface 1124. Communications interface 1124 might be used to allow software and data to be transferred between computing system 1100 and external devices. Examples of communications interface 1124 might include a modem or softmodem, a network interface (such as an Ethernet, network interface card, WiMedia, IEEE 802.XX, Bluetooth® or other interface), a communications port (such as for example, a USB port, IR port, RS232 port, or other port), or other communications interface. Software and data transferred via communications interface 1124 might typically be carried on signals, which can be electronic, electromagnetic (which includes optical) or other signals capable of being exchanged by a given communications interface 1124. These signals might be provided to communications interface 1124 via a channel 1128. This channel 1128 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1108, storage unit 1120, media 1114, and channel 1128. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing system 1100 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent component names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and embodiments, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various elements of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method comprising:
receiving a template request;
generating, on a first graphical user interface, a drafter interface corresponding to the template request, the drafter interface comprising a dynamically editable document and one or more prompts and corresponding selectable responses corresponding to the template requested, wherein a given prompt and its corresponding selectable responses correspond to one or more text editable sections of the dynamically editable document;
receiving a first set of one or more selectable responses to individual ones of the one or more prompts from a drafter;
invoking listeners corresponding to the template request in response to receiving the first set of one or more selectable responses, wherein the invoked listeners cause one or more text editable sections of the dynamically editable document to be edited based on the received first set of one or more selectable responses; and
distributing the first set of one or more selectable responses to the one or more prompts and a corresponding first set of one or more edits to the dynamically editable document to a reviewer.

2. The method of claim 1, further comprising:
generating, on a second graphical user interface, a reviewer interface corresponding to the drafter interface, the reviewer interface comprising the dynamically editable document, the corresponding first set of one or more edits, the one or more prompts, and the first set of one or more selectable responses;
receiving a second set of one or more selectable responses to individual ones of the one or more prompts from the reviewer;
invoking the listeners in response to receiving the second set of one or more selectable responses, wherein the invoked listeners cause the one or more text editable sections of the dynamically editable document to be edited based on the second set of one or more selectable responses; and
distributing the second set of one or more selectable responses to the one or more prompts and a corresponding second set of one or more edits to the dynamically editable document to the drafter.

3. The method of claim 2, wherein the drafter and the reviewer repeat the method of claim 1 and the method of claim 2 until a document is finalized, such that the drafter and the reviewer are in full agreement with regards to the one or more prompts and the dynamically editable document.

4. The method of claim 2, wherein the first set of one or more selectable responses is different than the second set of one or more selectable responses and the corresponding first set of one or more edits is different than the corresponding second set of one or more edits.

5. The method of claim 1, wherein causing the one or more text editable sections of the dynamically editable document to be edited comprises adding a first set of one or more segments to the dynamically editable document based on the first set of one or more selectable responses.

6. The method of claim 2, wherein the reviewer interface further comprises an issues list interface configured to present at least some of the one or more selectable responses where the drafter and reviewer disagree, corresponding prompts, a corresponding portion of the dynamically editable document, and the corresponding first set of one or more edits.

7. The method of claim 1, wherein the drafter interface further comprises a blackline interface configured to compare points in a history of the dynamically editable document.

8. A system comprising:
one or more servers;
one or more electronic storage units;
a non-transitory computer readable medium having machine readable instructions stored thereon which, when executed by one or more processing engines, causes the system to:
receive a template request;
generate, on a first graphical user interface, a drafter interface corresponding to the template request, the drafter interface comprising a dynamically editable document and one or more prompts and corresponding selectable responses corresponding to the template request, wherein a given prompt and its corresponding selectable responses correspond to one or more text editable sections of the dynamically editable document;
receive a first set of one or more selectable responses to individual ones of the one or more prompts from a drafter;
invoke listeners corresponding to the template request in response to receiving the first set of one or more selectable responses, wherein the invoked listeners cause one or more text editable section of the dynamically editable document to be edited based on the received first set of one or more selectable responses; and
distribute the first set of one or more selectable responses to the one or more prompts and corresponding first set of one or more edits to the dynamically editable document to a reviewer.

9. The system of claim 8, wherein the machine readable instructions, when executed by the one or more processing engines, further cause the system to:
generate, on a second graphical user interface, a reviewer interface corresponding to the drafter interface, the reviewer interface comprising the dynamically editable document, the corresponding first set of one or more edits, the one or more prompts, and the first set of one or more selectable responses;
receive a second set of one or more selectable responses to individual ones of the one or more prompts from the reviewer;
invoke the listeners in response to receiving the second set of one or more selectable responses, wherein the invoked listeners cause one or more text editable section of the dynamically editable document to be edited based on the second set of one or more selectable responses; and
distribute the second set of one or more selectable responses to the one or more prompts and a corresponding second set of one or more edits to the dynamically editable document to the drafter.

10. The system of claim 9, wherein the drafter and the reviewer repeat the steps of claim 8 and the steps of claim 9 until a document is finalized, such that the drafter and the reviewer are in full agreement with regards to the one or more prompts and the dynamically editable document.

11. The system of claim 9, wherein the first set of one or more selectable responses is different than the second set of one or more selectable responses and the corresponding first set of one or more edits is different than the corresponding second set of one or more edits.

12. The system of claim 8, wherein to cause the one or more text editable sections of the dynamically editable document to be edited, the machine readable instructions, when executed by the one or more processing engines, further cause the system to add a first set of one or more segments to the dynamically editable document based on the first set of one or more selectable responses.

13. The system of claim 9, wherein the reviewer interface further comprises an issues list interface configured to present at least some of the one or more selectable responses where the drafter and reviewer disagree, corresponding prompts, a corresponding portion of the dynamically editable document, and the corresponding first set of one or more edits.

14. The system of claim 8, wherein the drafter interface further comprises a blackline interface configured to compare points in a history of the dynamically editable document.

15. A method comprising:
generating, on a graphical user interface, a manager interface, the manager interface comprising one or more prompt section fields, one or more segment fields, one or more prompt fields, one or more response fields, and one or more listener fields;
responsive to input from a manager on the one or more prompt section fields, creating one or more prompt sections presented to a drafter;
responsive to input from the manager on the one or more segment fields, creating one or more segments presented to the drafter, wherein the one or more segments correspond to the one or more prompt sections;
responsive to input from the manager on the one or more prompt fields, creating one or more prompts presented to the drafter, wherein the one or more prompts correspond to the one or more prompt sections;
responsive to input from the manager on the one or more response fields, creating one or more responses presented to the drafter, wherein the one or more responses correspond to individual ones of the one or more prompts;
responsive to input from the manager on the one or more listener fields, creating one or more listeners that are invoked based on receiving the one or more responses from the drafter, wherein the one or more listeners correspond to the one or more prompt sections; and
generating a dynamically editable document template based on the manager's inputs, wherein the dynamically editable document template corresponds to a drafter interface for the drafter and wherein the drafter interface comprises a dynamically editable document and the one or more prompts and corresponding responses corresponding to the dynamically editable document.

16. The method of claim 15, wherein the one or more listener fields comprises one or more listener conditions and one or more listener actions.

17. The method of claim 16, wherein the one or more listener conditions are based on Boolean, multivariable, and other types of logic.

18. The method of claim 16, wherein the one or more listener actions modify the dynamically editable document such that the one or more segments are added to the dynamically editable document when the one or more listener conditions corresponding to the one or more listener actions are satisfied.

19. The method of claim 15, wherein the one or more prompt fields comprises one or more prompt types, such that the one or more response fields presented to the manager are modified based on selecting one of the one or more prompt types.

20. The method of claim 19, wherein the one or more prompt types comprises radio buttons, check marks, open-ended response fields, lists, complex lists, a drop-down menu, a date field, or a duration selector.

21. The method of claim 15, wherein creating one or more prompt sections also sets up a table of contents for the dynamically editable document template.

22. A system comprising:
one or more servers;
one or more electronic storage units;
a non-transitory computer readable medium having machine readable instructions stored thereon which, when executed by one or more processing engines, causes the system to:
generate, on a graphical user interface, a manager interface, the manager interface comprising one or more prompt section fields, one or more segment fields, one or more prompt fields, one or more response fields, and one or more listener fields;
responsive to input from a manager on the one or more prompt section fields, create one or more prompt sections presented to a drafter;
responsive to input from the manager on the one or more segment fields, create one or more segments presented to the drafter, wherein the one or more segments correspond to the one or more prompt sections;
responsive to input from the manager on the one or more prompt fields, create one or more prompts presented to the drafter, wherein the one or more prompts correspond to the one or more prompt sections;
responsive to input from the manager on the one or more response fields, create one or more responses presented to the drafter, wherein the one or more responses correspond to individual ones of the one or more prompts;
responsive to input from the manager on the one or more listener fields, create one or more listeners that are invoked based on receiving the one or more responses from the drafter, wherein the one or more listeners correspond to the one or more prompt sections; and
generate a dynamically editable document template based on the manager's inputs, wherein the dynamically editable document template corresponds to a drafter interface for the drafter and wherein the drafter interface comprises a dynamically editable document and the one or more prompts and corresponding responses corresponding to the dynamically editable document.

23. The system of claim 22, wherein the one or more listener fields comprises one or more listener conditions and one or more listener actions.

24. The system of claim 23, wherein the one or more listener conditions are based on Boolean, multivariable, and other types of logic.

25. The system of claim 23, wherein the one or more listener actions modify the dynamically editable document such that the one or more segments are added to the dynamically editable document when the one or more listener conditions corresponding to the one or more listener actions are satisfied.

26. The system of claim 22, wherein the one or more prompt fields comprises one or more prompt types, such that the one or more response fields presented to the manager are modified based on selecting one of the one or more prompt types.

27. The system of claim 26, wherein the one or more prompt types comprises radio buttons, check marks, open-ended response fields, lists, complex lists, a drop-down menu, a date field, or a duration selector.

28. The system of claim 22, wherein to create one or more prompt sections the machine readable instructions, when executed by the one or more processing engines, further cause the system to set up a table of contents for the dynamically editable document template.
